(19) United States
(12) Patent Application Publication
(10) Pub. No.: US 2010/0138745 A1
(43) Pub. Date: Jun. 3, 2010

(54) SYSTEMS AND METHODS FOR MANAGING THE PRODUCTION OF A FREE-VIEWPOINT AND VIDEO-BASED ANIMATION

(75) Inventors: Brendan McNamara, New South Wales (AU); Oliver Bao, New South Wales (AU); Douglas Turk, New South Wales (AU); Scott D. McMillan, New South Wales (AU)

Correspondence Address: Muncy, Geissler, Olds & Lowe, PLLC, 4000 Legato Road, Suite 310, FAIRFAX, VA, 22033, US

(73) Assignee: DEPTH ANALYSIS PTY LTD., Ultimo, New South Wales (AU)

(21) Appl. No.: 12/514,939

(22) PCT Filed: Nov. 15, 2007
(86) PCT No.: PCT/AU07/01755

§ 371 Date: Dec. 28, 2009

(30) Foreign Application Priority Data
Nov. 15, 2006 (AU) 2006906365

(51) Int. Cl. G06F 3/01; G06T 15/70

(52) U.S. Cl. 715/720; 345/473

(57) ABSTRACT

Described herein are systems and methods for managing the production of video-based animation, described particularly by reference to the example of free-viewpoint video-based animation. In overview, hardware, software, facilities and protocols described herein allow known and subsequently developed video-based animation techniques to be implemented in commercial environments in an improved manner, particularly as compared with the manner in which such techniques are implemented in a research and development environment.

### FIELD OF THE INVENTION

The present invention relates to video-based animation, and more particularly to systems and methods for managing the production of a free-viewpoint video-based animation.

Embodiments of the invention have been developed particularly form managing a process where video is captured from a plurality of video capture devices for processing to create a three-dimensional animation. Although the invention is described hereinafter with particular reference to this application, it will be appreciated that the invention is applicable in broader contexts.

### BACKGROUND

Any discussion of the prior art throughout the specification should in no way be considered as an admission that such prior art is widely known or forms part of common general knowledge in the field.

Various techniques are known for processing video footage to provide free-viewpoint video-based animations. Typically, a plurality of video capture devices are used to simultaneously capture video of a subject from a variety of angles, and the captured video is analyzed and processed to generate in a computer system a free-viewpoint video-based animation of the subject or part of the subject. In overview, each video frame is processed in combination with other video frames from the same point in time using techniques applied such as stereo matching, the application of controlled light patterns, and other methods known in the field of 3D photography. A three-dimensional model is created for each set of simultaneous frames, and models corresponding to consecutive frames displayed consecutively to provide a free-viewpoint video-based animation.

It is widely accepted that video-based animation technology has commercial application in fields such as video game development and motion picture special effects. However, applying known processing techniques to commercial situations is not by any means a trivial affair. The development of video-based animation techniques has to date been substantially directed towards technical considerations such as effective analysis and processing of captured frames and animation processing procedures. On the other hand, successful application of such techniques in a commercial environment involves overcoming hurdles such as time and resource management (including actor-management), meeting reliability requirements, and providing effective solutions for practical commercial implementation. For example, whereas it may be appropriate in a research and development environment to discover a need to re-capture video footage some time after the initial capture—for example upon viewing of the final animation after many hours of processing—in a commercial environment this might turn out to be a costly exercise.

It follows that there is a need in the art for systems and methods for managing the production of video-based animation.

### SUMMARY

According to one aspect of the invention, there is provided a method for managing the production of a free-viewpoint video-based animation, the method including the steps of:

obtaining data indicative of one or more operational characteristics of a capture subsystem, the capture subsystem being configured for controlling a set of video capture devices and for storing video captured at each of these devices on a first storage device, the set of capture devices being configured to define a capture zone in three dimensional space for containing a target object;

accepting as input a first command indicative of an instruction to commence video capture;

being responsive to the first command for selectively providing to the capture subsystem a second command indicative of an instruction to commence video capture at the capture devices;

identifying video capture files stored on the first storage device corresponding to video captured at each of the capture devices in response to the second command, the identified video capture filed representing a file set;

providing an interface for allowing playback of the file set, wherein the interface allows selective simultaneous display of a plurality of player elements each for providing synchronized playback of a respective one of the video capture files in the file set thereby to allow review by one or more persons of video captured in response to the second command;

accepting input indicative of either approval or rejection of the file set and, in the case of approval of the file set, providing a third command indicative of an instruction to move the file set to a rendering subsystem;

selectively providing additional commands to the rendering subsystem indicative of instructions to process the file set to produce a free-viewpoint video-based animation of the target object.

In some embodiments the first and second storage devices are defined by common hardware, for example partitioned regions of a common drive. In some cases whether a particular data item is on the first or second device is simply a matter of metadata—a data item might remain in the same physical location, but be “moved” by changing an attribute of metadata. In this manner, the movement between the first and second storage locations may be either physical or virtual.

According to a second aspect of the invention there is provided a system for managing the production of a free-viewpoint video-based animation, the system including:

a capture subsystem configured for controlling a set of video capture devices and for storing video captured at each of these devices on a first storage device, the set of capture devices being configured to define a capture zone in three dimensional space for containing a target object;

a rendering subsystem in communication with the capture subsystem, the rendering subsystem including one or more processors coupled to one or more second storage devices;

a computer-readable carrier medium carrying a set of instructions that, when executed by one or more processors on a client terminal in communication with the capture subsystem and the rendering subsystem, allow the client terminal to:
(a) accept as input a first command indicative of an instruction to commence video capture;
(b) process the first command and in response selectively provide to the capture subsystem a second command indicative of an instruction to commence video capture at the capture devices;
(c) identify video capture files stored on the first storage device corresponding to video captured at each of the capture devices in response to the second command, the identified video capture filed representing a file set;
(d) provide an interface for allowing playback of the file set, wherein the interface allows selective simultaneous display of a plurality of player elements each for providing synchronised playback of a respective one of the video capture files in the file set thereby to allow review by one or more persons of video captured in response to the second command;
(e) accept input indicative of either approval or rejection of the file set and, in the case of approval of the file set, providing a third command indicative of an instruction to move the file set to the rendering subsystem;
(f) selectively provide additional commands to the rendering subsystem indicative of instructions to process the file set to produce a free-viewpoint video-based animation of the target object.

According to a third aspect of the invention, there is provided a system for managing the production of a free-viewpoint video-based animation, the system including:

a capture subsystem configured for controlling a set of video capture devices and for storing video captured at each of these devices on a first storage device, the set of capture devices being configured to define a capture zone in three dimensional space for containing a target object;

a rendering subsystem in communication with the capture subsystem, the rendering subsystem including one or more processors coupled to one or more second storage devices;

at least one first client terminal in communication with capture subsystem for coordinating the capture of video at each of the capture devices;

at least one second client terminal in communication with capture subsystem for reviewing playback of video captured at each of the video capture devices;

at least one third terminal in communication with the capture subsystem for instructing the capture subsystem to transfer data indicative of stored video to the rendering subsystem;

at least one fourth terminal in communication with the rendering subsystem for providing commands to the rendering subsystem indicative of instructions to perform processing tasks on video stored by the rendering subsystem to produce a free-viewpoint video-based animation of the target object.

According to a further aspect of the invention, there is provided a system for managing the production of a free-viewpoint video-based animation of at least part of an actor, the system for operation by one or more persons including a controller and a director, the system including:

a video capture station including a set of video capture devices, the set of capture devices being configured to define a capture zone in three dimensional space for containing the part of the actor, the video capture station further including a first communications unit configured for audible communication with a second communications unit;

a controller station including a terminal for allowing the controller to initiate video capture at the set of capture devices and review video captured at each of the capture devices, the controller station further including the second communications unit such that the controller and actor are able to audibly communicate, the controller station further including a third communications unit configured for audible communication with a fourth communications unit;

a director station including a display for allowing the director to review video captured at each of the capture devices, the director station further including the fourth communications unit such that the controller and director are able to audibly communicate.

According to a still aspect of the invention, there is provided a method for managing the production of a free-viewpoint video-based animation of at least part of an actor, the method including the steps of:

providing a set of video capture devices and for storing video captured at each of these devices on a first storage device, the set of capture devices being configured to define a capture zone in three dimensional space for containing at least part of an actor;

instructing the actor to act out a scene at least partially within the capture zone;

instructing each of the capture devices to capture video of the scene;

reviewing acting characteristics of the captured video, and in the case that the acting characteristics do not meet a threshold acting quality standard, instructing the actor to act out a replacement scene;

reviewing technical characteristics of the captured video, and in the case that the acting characteristics do not meet a threshold technical quality standard, instructing the actor to act out a replacement scene;

in the case that the captured video meets the threshold acting quality standard and the threshold technical quality standard, providing an instruction indicative of approval of the captured video; and

being responsive to the approval of the captured video for commencing the generation of the animation.

According to a further aspect of the invention, there is provided a method for managing the production of a free-viewpoint video-based animation, the method including the steps of:
(i) accepting input indicative of a file set, the file set including a plurality of video capture files corresponding to a video scene captured simultaneously at each of a set of video capture configured to define a capture zone in three dimensional space for containing at least part of an actor;
(ii) applying one or more sequential predefined processing operations to the file set to provide a processing result having a tier associated with the final one or the sequential processing operations performed;
(iii) selectively repeating step (ii) for one or more further processing operations to the file set provide a further processing result having a tier associated with the final one or the sequential processing operations performed; and

wherein upon a threshold number of processing operations have been performed the processing result defines the free-viewpoint video-based animation.

According to a further aspect of the invention, there is provided a method for managing the production of a free-viewpoint video-based animation of a target object, the method including the steps of:

capturing video of the target object simultaneously at a plurality of video capture devices;

reviewing the captured video to determine whether the captured video meets one or more the threshold acting quality standard and the threshold technical quality standards;

in the case that the case that the captured video meets one or more the threshold acting quality standard and the threshold technical quality standards, commencing the generation of the animation.

According to a further aspect of the invention, there is provided a system for managing the production of a free-viewpoint video-based animation of a target object, the system including:

a capture subsystem configured for controlling a set of video capture devices and for storing video captured at each of these devices on a first storage device, the set of capture devices being configured to define a capture zone in three dimensional space for containing a target object;

a rendering subsystem in communication with the capture subsystem, the rendering subsystem including one or more processors coupled to one or more second storage devices;

a control subsystem in communication with the capture subsystem and the a rendering subsystem for managing the capture of video, review of captured video, and processing of captured video to generate the free-viewpoint video-based animation.

One embodiment provides a method for managing the production of one or more free-viewpoint video-based animations, the method including the steps of:
(a) providing an interface for allowing user-creation and submission of one or more groups of tasks related to the production of a free-viewpoint video-based animation, each group of tasks having an associated priority rating;
(b) being responsive to submission of a group of tasks for defining one or more subjobs for execution;
(c) on the basis of the priority rating for the submitted group of tasks and a set of dependency rules, adding the one or more subjobs to a prioritized processing queue; and
(d) being responsive to a signal indicative of resource availability at a processing node for providing the next subjob in the queue to the processing node.

One embodiment provides a method wherein step (a) includes providing to the user a selection interface for selecting one or more of a plurality of predefined tasks, wherein user creation of a group of tasks includes identifying one or more of the predefined tasks and, for each of the predefined tasks, target data.

One embodiment provides a method wherein the plurality of predefined tasks include one or more of the following:

full processing of a set of video data to provide a free-viewpoint video-based animation;

partial processing of a set of video data to provide an intermediate result in the production of a free-viewpoint video-based animation;

video editing of a set of video data;

data transfer of a set of video data from a first storage location to a second storage location; and

data transfer of a set of a file embodying a free-viewpoint video-based animation from a third storage location to a fourth storage location.

One embodiment provides a method wherein at least one of plurality of predefined tasks includes a plurality of default constituent subtasks.

One embodiment provides a method wherein the interface allows a user to modify the default constituent subtasks thereby to define custom constituent subtasks.

One embodiment provides a method wherein the target data includes at least a portion of a file set including video capture files corresponding to video simultaneously captured at each of a plurality of stereoscopically arranged capture devices.

One embodiment provides a method for managing the production of one or more free-viewpoint video-based animations, the method including the steps of:

maintaining a queue of pending subjobs, wherein the ordering of the queue is based upon a priority rating respectively associated with each subjob and a set of dependency rules concerning data input/output interrelationships between subjobs;

monitoring processing nodes in a network environment to determine available processing resources; and

being responsive to a node having suitable processing resources for providing the next subjob in the queue for execution at that node.

One embodiment provides a system for managing the production of one or more free-viewpoint video-based animations, the system including:

a processing subsystem including a plurality of processing modules;

a storage subsystem including a plurality of storage modules;

a monitoring subsystem for:
(i) maintaining a queue of pending subjobs, wherein the ordering of the queue is based upon a priority rating respectively associated with each subjob and a set of dependency rules concerning data input/output interrelationships between subjobs; and
(ii) monitoring the processing subsystem to determine available processing resources; and
(iii) being responsive to a given one of the processing modules having suitable processing resources for providing the next subjob in the queue for execution at that node.

### BRIEF DESCRIPTION OF THE DRAWINGS

Embodiments of the invention will now be described, by way of example only, with reference to the accompanying drawings in which:

FIG. 1 schematically illustrates a system according to an embodiment of the present invention.

FIG. 1A schematically illustrates a system according to another embodiment of the present invention.

FIG. 2 schematically illustrates a method according to another embodiment of the present invention.

FIG. 3 schematically illustrates a system according to another embodiment of the present invention.

FIG. 3A schematically illustrates a system according to another embodiment of the present invention.

FIG. 3B schematically illustrates a system according to another embodiment of the present invention.

FIG. 3C schematically illustrates a system according to another embodiment of the present invention.

FIG. 4 schematically illustrates a schematic exemplary screenshot relating to another embodiment of the present invention.

FIG. 4A schematically illustrates a schematic exemplary screenshot relating to another embodiment of the present invention.

FIG. 4B schematically illustrates a schematic exemplary screenshot relating to another embodiment of the present invention.

FIG. 4C schematically illustrates a schematic exemplary screenshot relating to another embodiment of the present invention.

FIG. 5 schematically illustrates a method according to another embodiment of the present invention.

FIG. 6 schematically a method according to another embodiment of the present invention.

FIG. 7 schematically illustrates a method according to another embodiment of the present invention.

FIG. 8 schematically illustrates a schematic exemplary screenshot relating to another embodiment of the present invention.

FIG. 9 schematically illustrates a method according to another embodiment of the present invention.

FIG. 10 schematically illustrates a system according to another embodiment of the present invention.

FIG. 11 schematically illustrates a method according to another embodiment of the present invention.

FIG. 12 schematically illustrates a method according to another embodiment of the present invention.

FIG. 13 schematically illustrates a method according to another embodiment of the present invention.

FIG. 14 schematically illustrates a method according to another embodiment of the present invention.

### DETAILED DESCRIPTION

Described herein are systems and methods for managing the production of video-based animation, described particularly by reference to the example of free-viewpoint video-based animation. In overview, hardware, software, facilities and protocols described herein allow known and subsequently developed video-based animation techniques to be implemented in commercial environments in an improved manner, particularly as compared with the manner in which such techniques are implemented in a research and development environment.

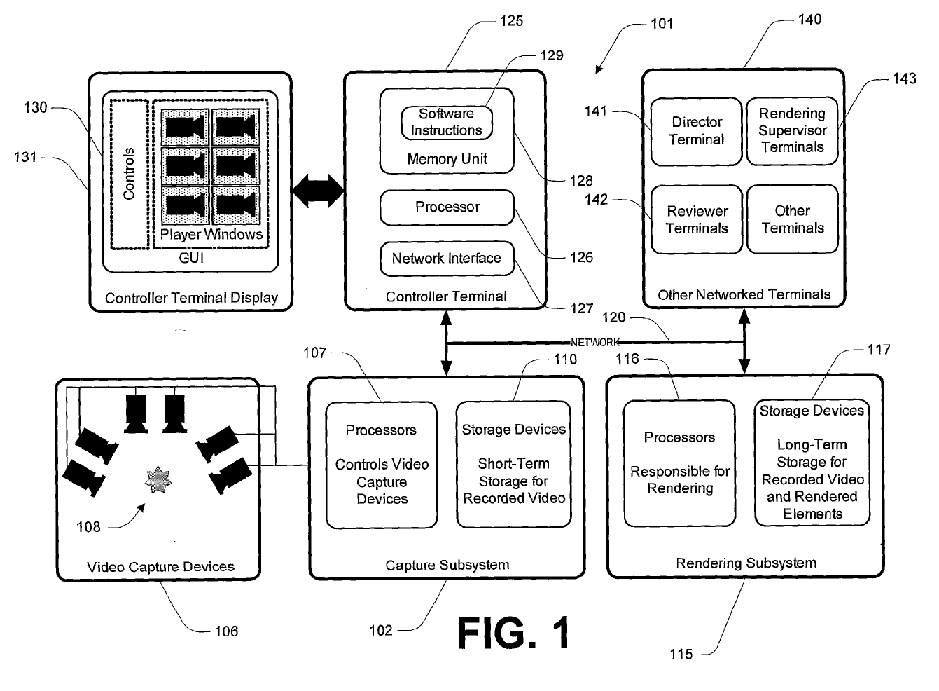

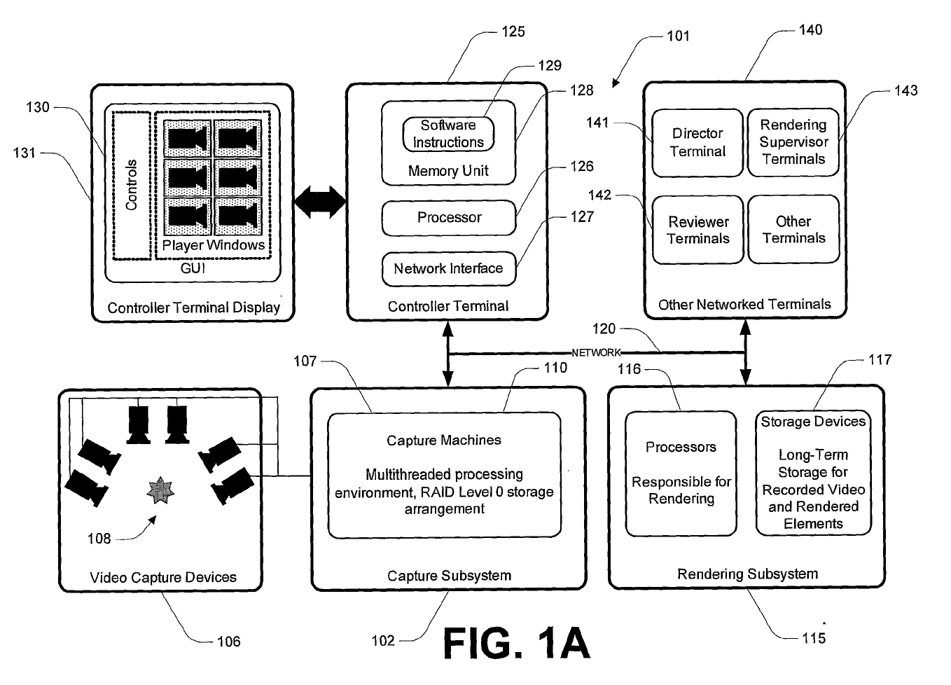

FIG. 1 illustrates an embodiment of the invention in the form of a system 101 for managing the production of a free-viewpoint video-based animation. In overview, system 101 includes various hardware and software components that allow video to be captured and subsequently processed to provide a free-viewpoint video-based animation.

System 101 includes a capture subsystem 102, which generally speaking provides for control of a set of video capture devices and for short-term storage of captured video. In the present embodiment, subsystem 102 is configured for controlling a set of video capture devices, in the form of digital video cameras 106. Cameras 106 are coupled to one or more processors 107 by respective digital video interfaces, an example of such an interface being an IEEE 1394 High Speed Serial Bus. Each processor is configured to execute the relevant device driver or drivers for the coupled camera or cameras. In some embodiments there is a one-to-one relationship between cameras and processors, however in other embodiments a plurality of cameras are coupled to each processor.

Cameras 106 are configured to define a capture zone 108 in three dimensional space. In overview, to create a video-based animation of a target object—such as an actor or part of an actor—the target object should be contained in zone 108. If any part of the target object leaves zone 108 during a scene capture, there is a relatively high probability that the generation of an animation for that scene capture will partially or wholly fail, or in some cases an animation produced will include serious deficiencies and/or flaws.

The term “take” is used herein to define a period of time defined by a capture commence event and a capture cease event. Video captured during that period of time is referred to as video of that take. On the other hand, the term scene describes the content, tempo, props and character movements, environments; the content that needs to be recorded. A take is an attempted recording of a scene. In practice, there can be multiple takes of a scene, with only the best one of these takes (from a technical and acting perspective) being selected for processing to produce a video based animation. Capturing a scene for second or subsequent take is also referred to as a re-capture.

Camera configurations shown in the present figures are provided for the sake of schematic illustration only, and should not be taken to infer any particular physical configuration. For example, the numbers of cameras in various embodiments range from as few as two to as many as one hundred, and perhaps even more in some instances. An appropriate number and configuration of cameras is selected based on available resources and video-based animation techniques that are to be applied.

The term “camera” as used herein refers to a hardware device having both optical capture components and a frame grabber for processing video signals such that digital video information is able to be obtained by subsystem 102 using a bus interface or the like. In some embodiments the optical capture components include an analogue CCD in combination with an analogue to digital converter for digitizing information provided be the CCD. In some embodiments optical capture components and a frame grabber are combined into a single hardware unit, whilst in other embodiments a discrete frame grabber unit is displaced intermediate an optical capture unit and subsystem 102. In one embodiment subsystem 102 includes one or more frame grabbers.

The term target object should be read broadly. Although embodiments described herein are particularly concerned with a target object in the form of an actor's face and/or head, it will be appreciated that a variety of other target objects are also used in some embodiments. These include both living creatures and inanimate objects. In the context of video game development is target objects often take the form of props—such as weapons or tools. In some embodiments objects require some modification before they are able to be effectively used as target objects, for example the application of a coating to reduce glare effects. Typically a capture zone having a particular location and volume is defined by positioning of cameras 106, and particular processing algorithms selected based on the type of target object. For example, in one embodiment a capture zone of 50 cm by 50 cm by 50 cm is used in conjunction with processing algorithms suited to face mapping.

Capture subsystem 102 is configured for storing video captured at each of cameras 106 on a first storage device 110. In the present embodiment storage device 110 includes a plurality of discs arranged in a RAID level 0 configuration and coupled to processors 107. A driving factor behind the selection of a RAID level 0 configuration is I/O performance, however there are associated downsides such as the risks associated with drive failure in such configurations. In the present embodiment device 110 is intended for relatively short-term storage, this assisting to manage risks associated with drive failure. In other embodiments alternate storage devices are used for device 110, including various clustered disc arrangements. In some embodiments a plurality of RAID configurations are used. In some embodiments distributed file systems are used, such as a General Parallel File System (GPFS).

Although processors 107 and storage device 110 are schematically illustrated in FIG. 1 as discrete elements, in some embodiments disks and processors in subsystem 102 are grouped into discrete capture machines. That is, a plurality of capture machines are provided, each capture machine for controlling and storing video captured at one or more of cameras 106. Each capture machine includes one or more of processors 107, and some or all of storage device 110.

In the embodiment of FIG. 1A, subsystem 102 includes a plurality of capture machines each having “n” cores, making use of multithreading architecture. Each capture machine is coupled to one or more of cameras 106 and to a RAID level 0 disk arrangement. In some embodiments a single RAID disk arrangement is shared among multiple capture machines, in other embodiments there is a one-to-one relationship. The number of cameras coupled to a given capture machine is selected based on I/O performance characteristics of that capture machine. In some embodiments there are between two and ten cameras coupled to each capture machine, and in some embodiments only a single camera coupled to each capture machine.

In some embodiments, where a RAID disk arrangement possesses sufficient resources (in terms of speed and/or capacity), there is a 1-to-many relationship between the RAID disk arrangement and the to capture machines (that is, a plurality of capture machines share a single RAID array).

From a definitional viewpoint, the term “captured video” is used herein to describe video that is both captured and recorded to disk. Captured video is viewed by reading the captured video files from the disk at which they are stored. This is distinguished from capture preview, which is viewed in substantial real-time. Capture preview is footage that is derived from cameras 106, but not necessarily being recorded. That is, capture preview is obtained directly from the cameras, as opposed to being read from a disk. Capture preview can be viewed substantially in real-time, although there is an inherent delay due to I/O, signal passage, and typically some buffering effects. Captured video can later be viewed by playback of stored video files.

System 101 also includes a rendering subsystem 115 which, generally speaking, provides a location at which captured video is processed/rendered for the purpose of animation generation and stored on a more permanent basis. In overview, captured video is initially stored at subsystem 102, reviewed, and subsequently moved to subsystem 115 such that the animation processing procedure can substantively commence.

The animation processing procedure includes a plurality of processing steps, each processing step selectively producing a processing result. Although subsystem 115 is referred to as a rendering subsystem, many of the processing steps carried out are not necessarily rendering steps in a strict technical sense.

Subsystem 115 includes processors 116 coupled to a second storage device 117. Whereas storage device 110 is in this embodiment selected primarily on the basis of I/O performance characteristics, storage device 117 is selected primarily on the basis of factors including storage capacity and reliability. As such, in some embodiments a relatively generic a file server arrangement is used. For example, a Network-Attached Storage (NAS) type arrangement. NAS is particularly useful in that the operating system and other software on the NAS unit provides only data storage data access functionalities, and the management of these functionalities. Processing platforms are able to view the NAS disk arrangement as a generic storage location. In other embodiments a SAN or similar arrangement is used.

In some embodiments, such as those discussed further below by reference to a JSM, speed plays a more critical role in assessing suitability of a particular hardware arrangement to play the role of storage device 117.

In one embodiment selection of appropriate hardware for storage devices 110 and 117 is primarily based on cost, given that cost savings may be realized by selecting storage devices that have particular strengths in either I/O performance or reliability and capacity, as opposed to selecting storage devices that excel in both of these areas. In some embodiments similar hardware and/or arrangements are used for both storage device 110 and 117, this producing better results in cases where cost containment is not a major issue.

Subsystem 102 and subsystem 115 are in the present embodiment connected over a high-speed Ethernet-type local area network 120, although in other embodiments alternate modes of communication are used. Network 120 allows for data transfer between storage device 110 and storage device 117, including the transfer of captured video (for example between capture and/or storage devices, and optionally to tape backup devices). Network 120 also allows other networked devices to access and review captured video, and to take control of various functionalities of subsystems 102 and 115—as discussed in detail below. One such networked device is a controller terminal 125.

Various terminals are described herein, such as “controller terminals” and “director terminals”. Different terms are used to designate differing functions, and should not be taken to imply a need for differing hardware. That is, a single computational platform could be used as either or both of a “controller terminal” and “director terminal”.

Controller terminal 125 takes the form of a personal computer, and includes a processor 126 coupled to an Ethernet network interface 127 and a memory unit 128. Memory unit 128 maintains software instructions 129 that, when executed on processor 126, allow processor 126 and terminal 125 to perform various methods including methods for managing the production of a free-viewpoint video-based animation.

In the present embodiment, software instructions 129 provide a graphical user interface (GUI) by way of a controller terminal display 131. In overview, GUI 130 is a software package that allows a user of terminal 125 to perform tasks such as configuring operational characteristics of cameras 106, controlling video capture at cameras 106, viewing capture preview footage at cameras 106, reviewing video captured at cameras 106 (including video stored on storage devices 110 and 117) and coordinating animation processing procedures to be carried out by processors 116.

In the present embodiment, captured video is able to be previewed at terminal 125 substantially in real-time as capture preview. “Substantially in real-time” should be read to infer real-time with only a minor delay—typically less than five or so seconds, and in some embodiments less than about one second. These delays are introduces by some minor buffering and signal transfer effects.

In some embodiments cameras 106 operate in conjunction with an audio capture system including one or more microphones. Although audio capture and playback aspects are for the most part ignored for the purpose of the present disclosure, it should be inferred that wherever video is viewed in substantial real-time or played back, corresponding audio is also optionally simultaneously played in substantial real-time or played back. From a practical perspective, similar synchronization equipment is used to synchronize device clocks in both video and audio capture equipment so allow synchronicity between frames captured a corresponding times at varying cameras and audio captured at corresponding times. Audio files relating to video file sets are typically stored and transferred in the same or a similar manner to the video file sets, often along with context data also relating to the video file set.

In some embodiments there is a varied delay in the substantial real-time display of audio and video, resulting in a minor lip-synch issue. This issue is minor in that firstly real-time video playback is typically of a relatively low quality with not every video frame being shown on-screen (even though every frame is captured and stored), and secondly given that delays in audio and video are typically of a similar magnitude. These synchronization issues do not apply in subsequent playback of recorded video.

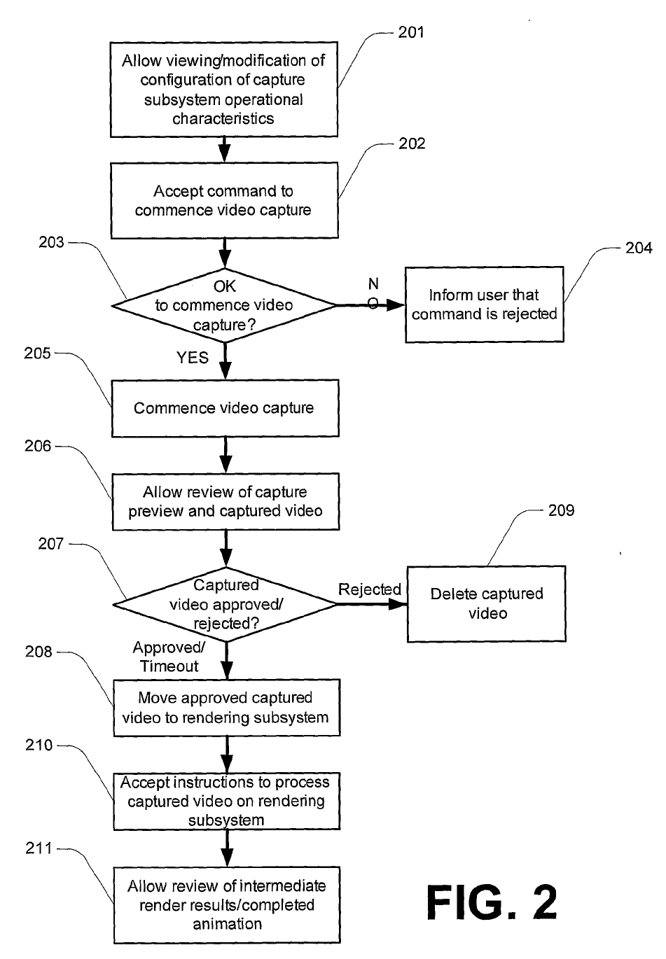

FIG. 2 illustrates in broad terms a method 200 according to an embodiment of the present invention, this method being described herein as performed GUI 130 running on terminal 125 based on software instructions 129.

Sub-process 201 includes obtaining data indicative of one or more operational characteristics of capture subsystem 102. In one embodiment these operational characteristics include operational characteristics of cameras 106 such as camera make/model, capture settings (white balance, etc) and status, as well as which of processors 107 are controlling each of cameras 106. On the basis of information obtained, GUI 130 allows a user to view and where applicable modify such operational characteristics of subsystem 102.

Sub-process 202 includes accepting from a user a first command indicative of an instruction to commence video capture. This command is typically initiated by the pressing of an appropriate “commence capture” button in GUI 130. Sub-process 203 includes being responsive to the first command for determining whether predefined conditions are met prior to actually commencing video capture. In one embodiment these conditions include access permissions, camera availability, appropriate configuration of GUI 130 and subsystem 102, and so on. In one embodiment one or more of these conditions are assessed prior to the “commence capture” button being made available—for example the button is “grayed out” until various conditions are satisfied. It will be appreciated that a number of alternate error management mechanisms are implemented across embodiments, including the use of error messages or “beeps” in the event that a user attempts to access a functionality or perform an action that is impermissible or inappropriate in the specific circumstances.

In one embodiment a preliminary initialization stage is optionally or compulsorily performed prior to initiating capture. This provides for a first level of error checking by conducting tests to ensure that subsystem 102 is reachable, capture device drivers at subsystem 102 are functioning properly, and the cameras are operating at an appropriate frame rate. It will be appreciated that frame rate can be tested without a need to commence capture, and simply by analysis of capture preview. In an embodiment where a professional actor is being filmed, such an initialization phase reduces the risk of a failed take capture due to avoidable hardware faults. There is often a particular sensitivity in this regard—acting is arguably in some instances a unique and non-repeatable event. If an actor is repeatedly asked to perform a re-take of a given scene due to technical glitches (even though the standard of acting is appropriate), and actor is likely to become frustrated. Embodiments of the present invention are particularly directed towards objectives such as maintaining actor satisfaction. It will be appreciated that implementing an “actor friendly” system greatly chances the likelihood of achieving high quality results from actor performance.

If the predefined conditions are not met, the command is rejected and the user informed at 204. Otherwise, capture commences at 205.

Sub-process 205 includes providing, to subsystem 102 a second command indicative of an instruction to commence video capture at each of cameras 106. In an ideal situation subsystem 102 is responsive to this command for capturing video at each of the cameras, however there may be cases where this does not occur. For example due to a camera hardware failure or an I/O failure at subsystem 102. Such events are recognized upon review of captured footage (or in some cases “uncaptured” footage—footage that should have been captured based on instructions provided, but that was not captured due to hardware failure or the like). This is discussed in more detail further below.

Although not explicitly shown in FIG. 2, method 200 includes an event where video capture is ceased. Such an event is typically triggered by a positive user command to cease capture. From a definitional standpoint, a portion of captured video defined by the initiation and cessation of video capture define a take.

During the capture process, subsystem 102 continually records a plurality of video files to storage device 110, each video file corresponding to video captured at one of cameras 106. These files remain open for further recording until the capture process completed, at which time the files are closed. Files are closed at the end of each take, whether it is successfully finished or canceled by user. From a terminology perspective collection of video files recorded during a single continuous capture period are referred to as a file set relating to a common take.

Sub-process 206 includes identifying video capture files stored on the first storage device corresponding to video captured at each of the capture devices in response to the second command—the file set for a take that is either in the process of being captured or that has just been captured. Statistics for each of these files is provided by way of GUI 130 to allow analysis of factors such as dropped frames and the like. A user is informed in the case that these statistics suggest that video capture at any one of the cameras has either failed or alternately not met threshold frame quality requirements.

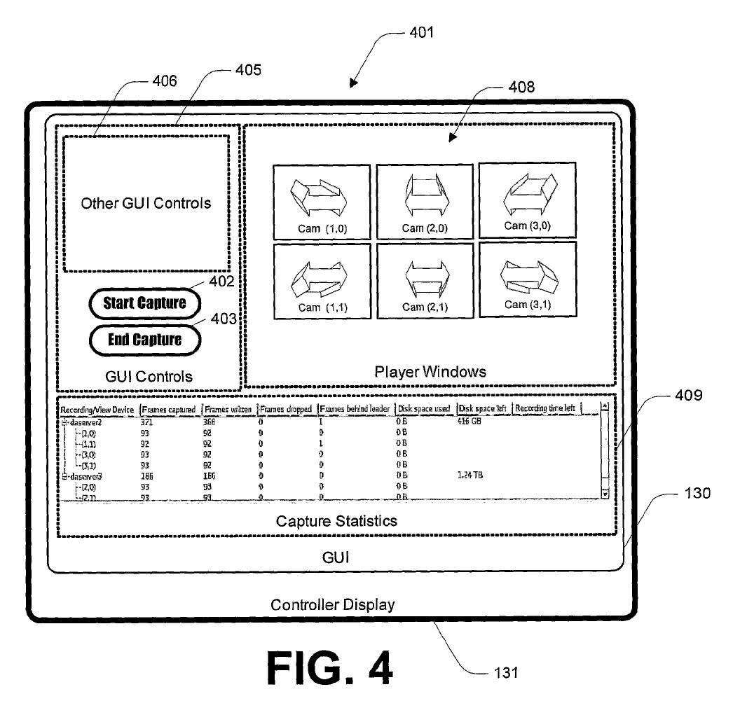

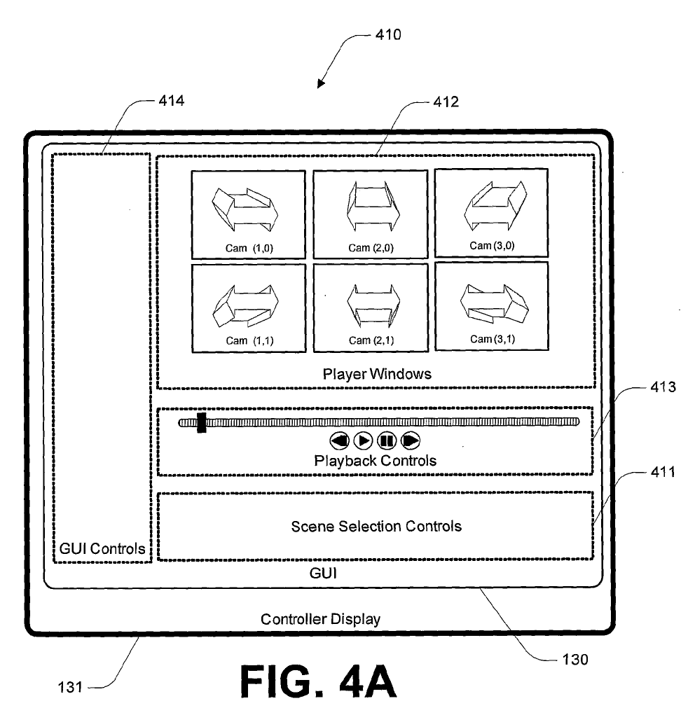

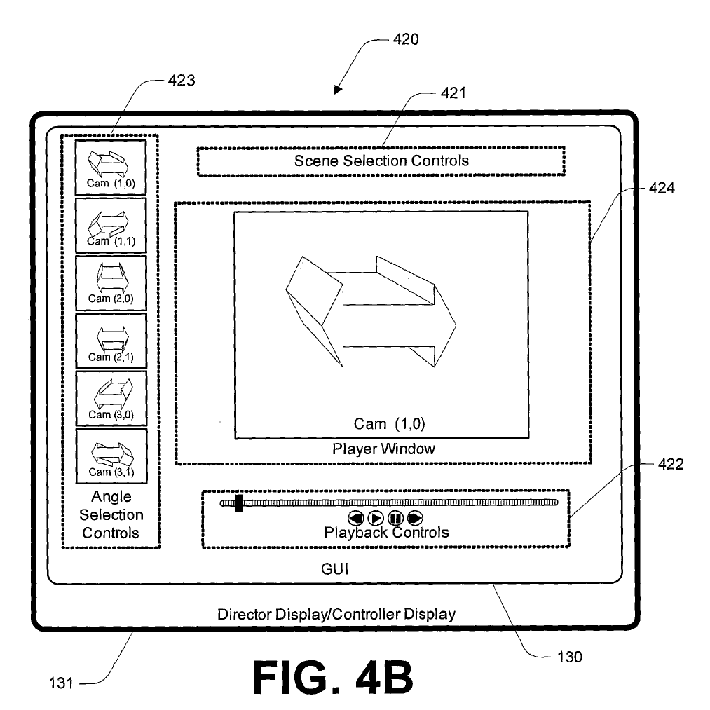

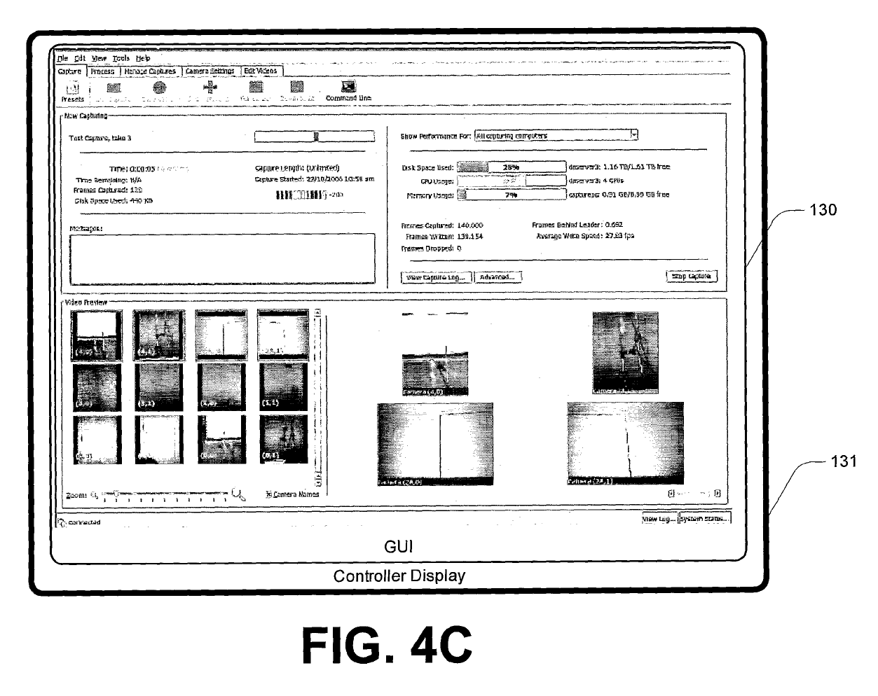

Sub-process 206 also includes providing an interface for allowing viewing of capture preview in substantial real-time, and for allowing playback of a file that has recently been captured. Playback of a file set includes providing simultaneous synchronized playback all or some of the individual files in the file set. In one embodiment this is achieved by allowing selective simultaneous display of a plurality of player elements each for providing synchronized playback of a respective one of the video capture files in the file set. An exemplary interface is described in more detail further below by reference to FIG. 4.

It will be appreciated that the ability to display footage is constrained by CPU and network limitations. Where sufficient CPU and network resources are available, multiple views are above to be displayed in real time, or close to real time.

A user of terminal 125 able to watch captured footage of a take from the angles provided by some or all of the cameras, and review this footage for either or both of technical characteristics and acting characteristics. In overview, acting characteristics are subjective directorial considerations—whether an actor had the right tone of voice, whether a script was read appropriately, etc. On the other hand, technical characteristics are relatively objective considerations understood by a person familiar with the proposed animation processing procedure—whether the target object (for example an actor's head) left the capture zone, whether the cameras are all functioning appropriately, whether there are problematic lighting/movement/background aspects, etc.

Upon optionally completing technical and directorial review of captured footage, a user provides input indicative either approval or rejection. At 207 GUI 130 is responsive to of either approval or rejection of the file set and, in the case of approval, providing at 208 a third command indicative of an instruction to move the file set in question to rendering subsystem 115. In the case of rejection the file set is deleted from storage device 110 at 209. In some embodiments this deletion occurs at the time of rejection, whereas in other embodiments it occurs periodically (i.e. multiple rejected files are deleted periodically, either of a regular basis of upon predefined resource limitations being realized). Optionally, deletion is subject to a user deletion-confirmation process.

In the present embodiment approval is inherently inferred after a predetermined time period, which may be user specified, such that file sets are automatically moved. In one instance this time period is a one hour period during which a file set has not been accessed. Rationales for such an approach include disc space management in device 110 to reduce the need to inhibit later captures due to storage deficiencies, and management of risks associated with failure of storage device 110.

In one embodiment GUI 130 allows the video files for a take to be cropped prior to approval. Cropping refers to a process whereby user-defined start and end points are manually defined on a timeline for a capture set. These user-defined start and end points are used to define the start and end one or more portions of a captured take that are to be converted into video-based animations. The general rationale for this approach is to reduce wasted storage on the rendering subsystem by reducing the amount of video frames that are stored irrespective of the fact that they would not be the subject of an animation, and also to reduce the likelihood of processing resources and time being consumed in processing frames that are not required.

In some embodiments such points are definable using a graphical representation of a timeline, whilst in other embodiments they are definable based numerical frame identifiers.

In one example, an actor is instructed that capture has commenced, and there is a brief period of time between the provision of the instruction and acting actually commencing. For instance, whilst the actor clears his throat or getting into character mentally. This period is trimmed out using a user-defined start point. If the acting commences after five second of capture, the user defined start point is defined five seconds into the captured footage. The initial five seconds is subsequently not transferred to the rendering subsystem, and is discarded.

In another example an actor is read a first line, acts out that first line, is read a second line, acts out that second line, and so on. All this time, video capture continues. Following completion of capture and review by a controller and director, each portion of the take where the actor has acted out a line with satisfactory acting and technical characteristics is identified by user-defined start and end points. In some cases this will only involve the identification of a single portion, in some cases numerous portions. For each identified portion, an individual file set is defined and provided to the rendering subsystem for processing.

From a practical perspective, in one embodiment the process of cropping an existing take results in the definition of a new take, having its own file set in which each file has been correspondingly cropped.

It will be appreciated that this cropping functionality is similar to cropping functionalities provided in many video editing software packages, although the cropping effect is applied to a plurality of video files in parallel. In some embodiments other video effects are able to be applied by GUI 130 in a similar manner, such as splitting and merging. In some embodiments one or more of cropping, merging and splitting are applied to a file set that is stored at the rendering subsystem.

In some embodiments other data is also provided to subsystem 115 for association with a given file set. This typically includes context data, such as:
Calibration data for cameras 206. Such data identifies at which of cameras 106 video was captured for each file in the file set, and the spatial locations of those cameras.
Video or image data of an empty target zone 108. This makes it easier for distinctions to be made between foreground and background information during the animation processing procedure. This data is optional, and not required in some embodiments.

Sub-process 210 includes accepting commands from a user in relation to the animation processing procedure where captured video is processed to provide video-based animation. In response to these commands GUI 130 selectively provides additional commands to the rendering subsystem indicative of instructions to process a selected file set to produce a free-viewpoint video-based animation of the target object, or at least to provide on or intermediate render results in relation to the production of a free-viewpoint video-based animation. This animation processing procedure is discussed in more detail further below, for example by reference to a JSM that is implemented to create a processing pipeline. Completed animations and intermediate render results optionally produced as part of generating final animations are viewable at 211.

In some embodiments GUI 130 provides basic 3D visualization tools to allow basic editing of a 3D animation without the need to export to a third party application (such as Maya or the like). It will appreciated that such an approach reduces delays caused by the need to export data to a third party 3D visualization tool, perform basic editing, and re-import.

Referring again to FIG. 1, other terminals 140 are also connected to network 120. Each of terminals 140 includes respective memory units and processors for providing GUI 130. In such an embodiment GUI 130 becomes a universal interface for management of system 101 for the purpose of producing free-viewpoint video-based animation. This has practical advantages in the sense that a single common software package may be installed on all relevant terminals in a production facility. In one embodiment users are provided with access codes for using GUI 130, each access code granting the user in question a certain level of access rights. In one embodiment access rights are defined as follows:
Reviewer Level. A user at this level is able to review video files, completed animations and intermediate render results stored on subsystem 115.
Renderer Level. A user at this level is able to review video files, completed animations and intermediate render results stored on subsystem 115, create new completed animations and intermediate render results by providing rendering commands, and modify/delete files stored at subsystem 115.
Controller Level. A user at this level has the access rights mentioned above, and additionally is able to control cameras 106, for example to initiate or end capture. Such an access level is provided to the intended user of terminal 125, or in some embodiments to any user provided he or she is logged on to terminal 125. In some embodiments controller level is only available from a designated controller terminal 125, regardless of the level of access a user has. It will be appreciated that there is a sensitivity to ensure that only a single user has access to camera control during a given time period. In some embodiments a user at this level additionally has access to audio and lighting hardware that is controllable via an integrated control system.

In some embodiments there is an Editor Level. For example, in some cases it is the user's sole responsibility to perform video editing operations (such as cutting or clipping) on approved takes to remove extraneous video data. In some cases this user also checks whether camera angles are suitable. It will be appreciated that such an approach is advantageous in the sense that it allows a specialist in such editing to be engaged for this specific purpose.

These access levels are provided for the sake of example only, and should not be regarded as limiting in any way. In other embodiments a wide arrange of alternate access management approaches are implemented, including both technically-enforced methods as described above and honesty-based methods where users are expected not to exceed permissions associated with their task in a production process.

It will be appreciated that subsystem 102 provides limited I/O resources, and as such there are advantages gained from limiting access to these I/O resources. This is particularly important during times when video capture is being conducted. In one embodiment when a controller is logged on, or in some cases where a controller initiates a “capture mode”, a sharing protocol is invoked such that access by other users to I/O resources of subsystem 102 is either denied or limited.

As shown in FIG. 1, terminals 140 include a director terminal 141, reviewer terminals 142, and rendering supervisor terminals 143. These terminals in some embodiments make use of similar or identical hardware, and described notionally by reference to functional roles they each play in an exemplary production process. To summarize one example based on the terminals shown in FIG. 1, controller terminal 125 is used to initiate/end video capture, and for some review of technical characteristics. Director terminal 141 is used primarily for review of acting characteristics. Reviewer terminals 142 are optionally used for further review of technical characteristics of captured footage. Rendering supervisor terminals are used to manage the animation processing procedure in rendering subsystem 115.

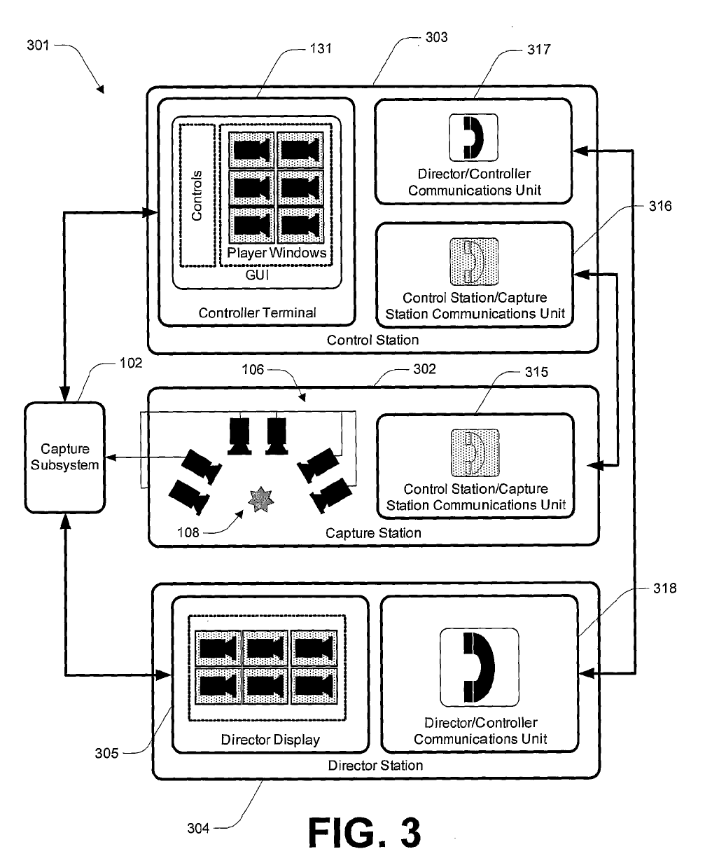

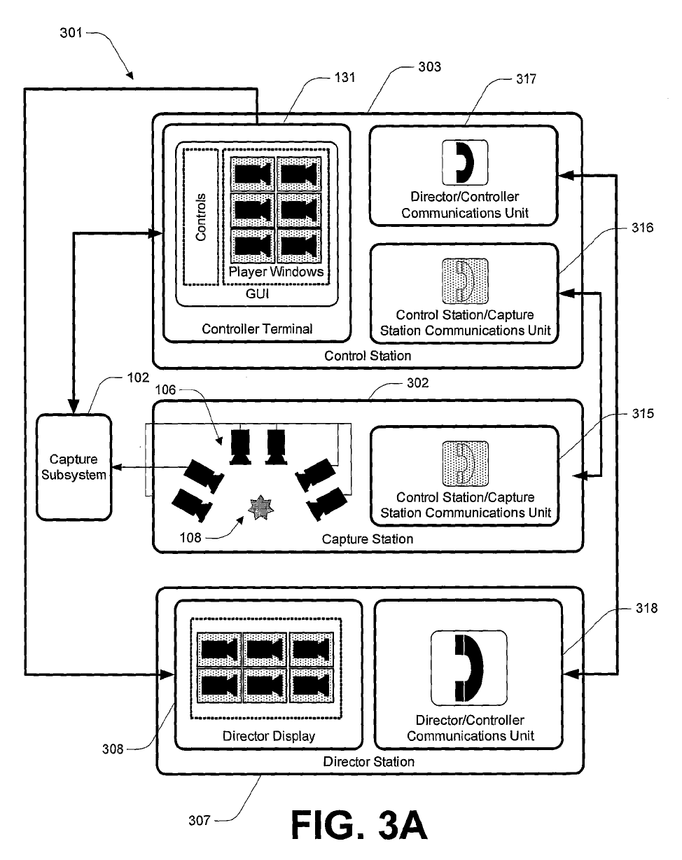

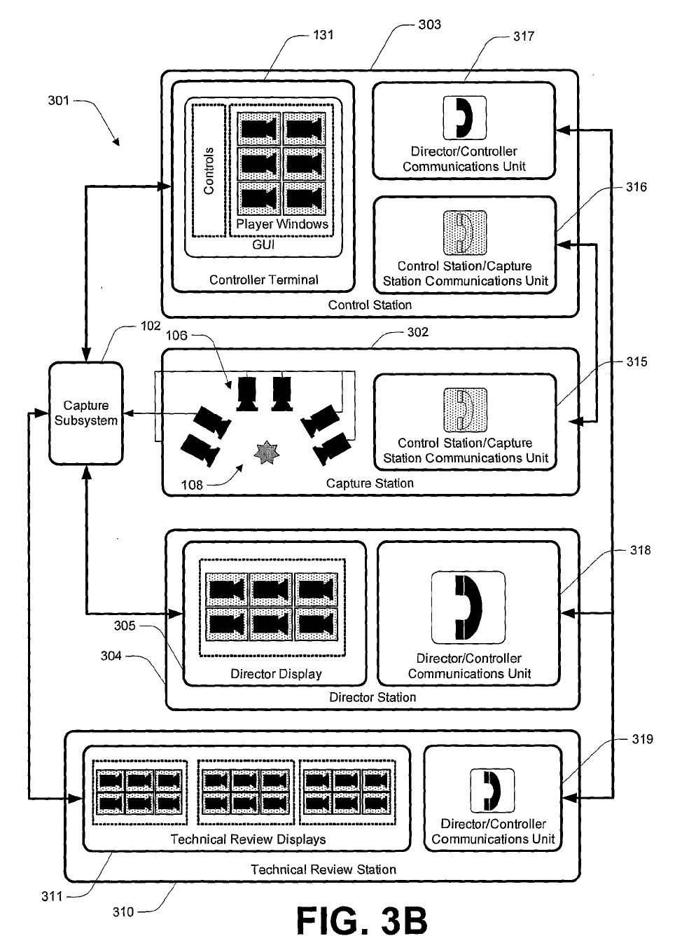

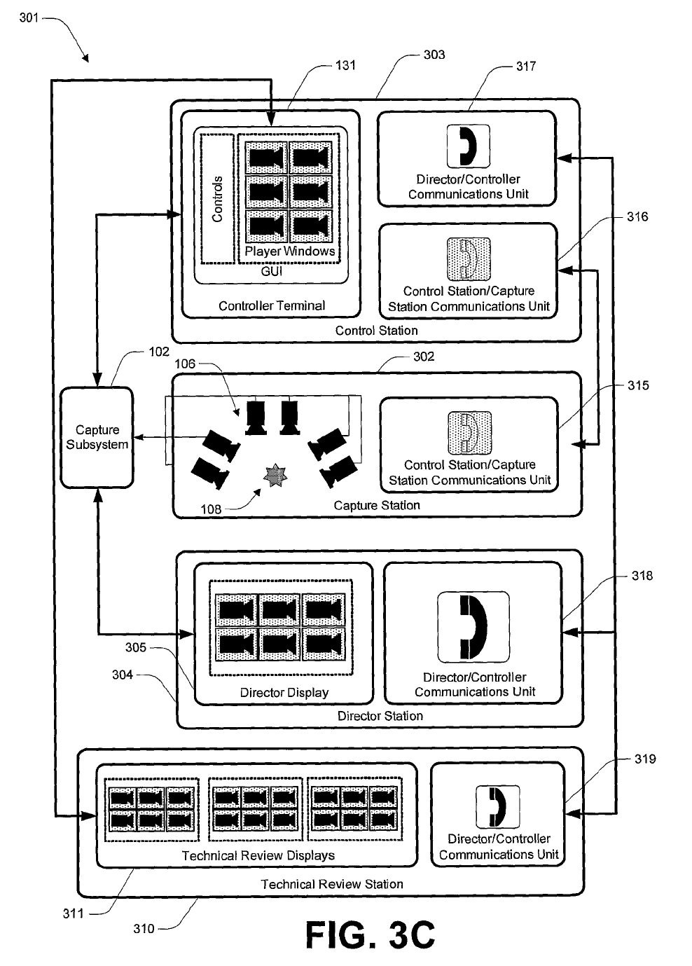

FIG. 3 illustrates a system, in the form of production facility 301, for managing the production of a free-viewpoint video-based animation of at least part of an actor, in this instance being the actor's face. In the described embodiment, facility 301 operates in conjunction with system 101. It will however be appreciated that facility 301 is able to operate in conjunction with other video-based animation systems.

Facility 301 is for operation by a controller, who is primarily responsible for implementing technical aspects, and a director, who is primarily responsible for implementing artistic aspects. In some embodiments a single person adopts the role of both controller and director, however the embodiment of FIG. 3 is particularly geared towards commercial environments where professional actors and professional directors are involved in the production of free-viewpoint video-based animations.

The involvement of professional actors in the production of video-based animation introduces various complications, particularly relating to actor management. Professional actors are often an expensive resource, and typically not available on-demand. In many situations a brief and limited period of time is available to capture footage of a particular actor, and following that period it is expensive, impractical or indeed impossible to capture additional footage of that actor. Such complications often compound with time—the later a fault in captured video is discovered, the less practical it will be to re-capture the take in question. As discussed below, facility 301 allows captured footage to be reviewed quickly end efficiently such that deficiencies in captured footage are able to be identified at an early stage. This is particularly distinguished from prior art systems where deficiencies are typically only identified at a later stage, typically after some degree of time and resource consumptive rendering has been carried out.

In some embodiments a “fast forward” processing functionality is provided whereby some processing deficiencies are able to be anticipated (and thereby avoided) at an early stage. In one embodiment, this includes immediate (or substantially immediate) processing of every Nth frame in a file set, with N typically in the order of 10 (i.e. only 1 out of every 10 frames is processed). In one embodiment a test target is used for this purpose, such as a sphere having a known pattern on its surface. It will be appreciated that such an approach is particularly useful to determine if the capture setup and calibration are accurate.

Facility 301 includes a video capture station 302. Station 302 is in one embodiment a room in which cameras 106 are arranged to define zone 108 in which an actor stands during take capture. Station 302 also includes lighting equipment, audio capture equipment to complement cameras 106, and typically is configured for soundproofing and/or acoustics. A trigger subsystem for hardware components in the capture station (such as audio/video/lighting hardware) is optionally provided, this being controllable by signals emanating from a control terminal.

Facility 301 also includes a controller station 303. This controller station is in one embodiment located in a separate room to the capture station. The controller station includes terminal 125 and display 131 such that a human controller is able to initiate video capture at the set of capture devices and review video captured at each of cameras 106. FIG. 4A and FIG. 4B shows exemplary screenshots 401 and 410 of GUI 130 as displayed on display 131 at the controller station. These screenshots are schematic representations only, and provided simply for the sake of explanation. They should not be regarded as limiting in any way, and it will be appreciated that a variety of GUI interfaces having differing screen layouts and features are used in other embodiments.

Referring to FIG. 4, screenshot 401 shows GUI 130 in a “capture mode”. A distinguishing feature of this mode is the presence of buttons 402 and 403, respectively used to commence or cease video capture at cameras 106. These buttons are part of a control interface 405, which also includes other controls 406 for accessing other functionalities of GUI 130. A plurality of player elements 408 are provided, these initially showing capture preview footage at each of cameras 106. The capture preview footage is shown substantially in real-time, noting that there is some delay due to signal transmission, processing, and buffering. This delay is typically less than about five seconds.

In some embodiments full screen and/or dual screen playback is provided at or close to full frame rate. It will be appreciated that this requires a reasonable degree of CPU speed so as to compress images faster at a high rate, and thereby reduce network delays. In some cases CPU performance is such that display of this nature is only acceptable for the purpose of judging acting characteristics, as opposed to technical characteristics.

One embodiment makes use of a GUI having three display level options:
Small with slow frame rates for preview purposes at a system level to check coverage and camera online status. One display mechanism is provided per camera.
Medium with tolerable substantially real-time displays. This allows a controller to maintain an overview, and then select specific views mentioned above (i.e. the small ones) for closer inspection.
Large to full screen display with lossy compression for the purpose of checking the content of a single camera at or close to real time.

It will be appreciated that with improved hardware it is possible to scale beyond a single full-screen display.

Following the pressing of button 402, video capture begins. Player elements 408 continue to show capture preview, however this capture preview can subsequently be reviewed as captured video. During capture, the quality of capture preview often decreases due to resource consumption associated with recording.

Screenshot 401 also shows a “capture statistics” element 409, this element showing statistics relating to captured video, again substantially in real-time. These statistics include, but are not limited to:
For each server in subsystem 102, a list of the cameras coupled to that server.
For each server in subsystem 102, and for each camera coupled to subsystem 102, details of the number of frames captured, the number of frames written to disk, and the number of frames dropped.
For each server in subsystem 102, details of available disk space and, from this, the maximum remaining capture time.

Such statistics assist the controller in performing a technical review of captured footage. If problems are observed—such as a large number of dropped frames—the controller is able to stop capture, optionally look into the problem, and immediately inform the actor and director that the scene will need to be re-captured.

As foreshadowed, technical characteristics determine the degree to which captured footage is suitable for rendering to produce video-based animation. A controller should be familiar with the overall animation processing procedure, and as such understand the implications of technical characteristics of a particular take of captured video. When reviewing technical characteristics, the controller reviews aspects including but not limited to the following:
Whether the target object (for example the actor's head) remained wholly within the capture zone for the entire take, or at least for a desired portion of the take. The controller reviews this by observing playback from each of the cameras, and ensuring that the target object remains wholly in-frame from each of the views provided by the cameras. It may be, in one exemplary situation, that an actor who's head is to be the subject of a video-based animation moves in such a way as to take a part of his head out of frame for one or more of the cameras. Such a take should be re-captured otherwise it will be difficult or impossible to provide a quality animation of the take in question. In some embodiments tracking software is implemented to autonomously assess whether a particular object remains within the vision of a camera for the duration of a take. Although this requires additional processing resources, in situations where there are a large number of cameras (for example in the case of full-body capture, which may use upwards of 150 cameras) non-automated human monitoring becomes less feasible.
Whether the cameras are all functioning appropriately. For example, it may be that one or more cameras are providing low-quality footage, providing footage having inappropriate white balance characteristics, providing no footage at all, dropping frames, and so on. In some embodiment GUI 130 provides a display for monitoring some of these characteristics, as discussed further below. Other examples include file I/O errors on one of the capture servers, a capture server running low on disk space, a camera capturing too many or two few frames (indicating that camera is likely out of synchronization, a capture server that is not writing frames to disk quickly enough, or a camera not capturing frames when other cameras are.
Whether there are problematic lighting/movement/background effects. For example, some shadows can adversely affect animation processing procedures. Also, an unwanted person moving in the background can be problematic.

Screenshot 450 in FIG. 4C provides an alternate capture mode screen according to another embodiment.

Screenshot 410 shows GUI 130 in a “playback” mode. The playback mode provides take selection controls 411 for allowing the controller to identify a take for controllable and repeatable review. In one embodiment, upon “end capture” button 403 being pressed, GUI 130 inherently progresses to playback mode with the just-captured take loaded for playback. Video files are displayed in player elements 412, and a user simultaneously navigates through these files using playback controls 413. Controls 413 resemble controls conventionally used in similar media players, including the likes of “play”, “pause”, “frame advance”, and a scrollable timeline. General GUI controls 414 are also provided. In some embodiments element 409 is also shown in playback mode.

As noted further below, screens shown on the controller display are in some embodiments replicated on additional displays, such displays also being coupled to the director terminal.

Facility 301 also includes a director station 304. Station 304 allows a director to review captured footage on a director display 305. One rationale for such an approach is to allow the director to view captured video without subsidiary clutter that might be shown on the display of terminal 125, such as GUI controls and technical monitoring data. For example: in a full-screen mode. In some embodiments, a full-screen mode is implemented in or close to real time by making use of lossy compression (such as JPEG).

In the embodiment of FIG. 3, director display 305 is coupled to a director terminal in communication with subsystem 102 such that a director is able to manually control playback at his/her own pace. That is, the director is provided with playback controls by way of GUI 130. The playback controls provided to a director are, in one embodiment, selected to allow simplified playback thereby to isolate a director from various technical controls that are not needed by the director and that may otherwise distract and/or confuse the director. For example, the controller configures the director terminal to provide only a selection of playback controls, or operate in a full-screen mode. It will be appreciated that the director's task is to review captured footage for subjective directorial considerations. In overview, the director reviews a take and makes a judgment call regarding whether or not he/she is satisfied with the standard of acting. Where the director is not satisfied with the standard of acting the take is re-captured, typically following the director providing instructions to the actor. It will be appreciated that the director need not review all captured angles—typically only one angle or a reduced selection is sufficient to judge acting characteristics.

In the embodiment of FIG. 3A, a director station 307 includes a director display 308. Display 308 is coupled to terminal 125 rather than to an individual director terminal. In this embodiment the controller controls video playback, and video playback shown on the display of terminal 125 is replicated on display 308. In practice, the director provides verbal instructions to the controller in relation to what the director wishes to see. An advantage of this approach over that of FIG. 3 stems from a reduction in I/O resource consumption at subsystem 102 as only a single terminal is accessing data. However, it will be appreciated that the director is provided with the same display output as the controller. A downside to this approach is that the controller is required to control playback on behalf of the director, however in some embodiments this is viewed as a reasonable trade-off for I/O conservation.

In some embodiments additional video equipment is used in parallel to that required for capturing video in connection with a video-based animation. For example, in some embodiments a secondary video system (such as a webcam other low-bandwidth system) is implemented to allow monitoring of the capture station at either or both of a controller station and director station.

FIG. 4B shows another exemplary screenshot 420 from GUI 130, this being a simplified review mode. Take selection controls 421 allow the controller (or director in the case that this screen is being shown on a director terminal) to navigate between takes to select a take for review. Playback controls 422 allow the controller to review a selected take, which is displayed on minor player elements 423 and a major player element 424. Elements 423 double as buttons, and allow the controller to select which view should be provided in the major player element.

In some embodiments the controller is solely responsible for reviewing technical characteristics of a captured take, however in other embodiments the controller is assisted by one or more further technical reviewers. For example, the embodiments of FIGS. 3B and 3C shows technical review stations 310 including one or more technical review displays 311. In the embodiment of FIG. 3B the or each display 311 is coupled with a respective reviewer terminal 142 in communication with subsystem 102. In the embodiment of FIG. 3C the or each display 311 is coupled to terminal 125. It will be appreciated that a terminal such as terminal 125 is able to support a plurality of displays, subject to performance parameters of a graphics card that is used.

In practice, a technical reviewer reviews captured video for technical characteristics. In one embodiment each reviewer is assigned one or more of cameras 106. One underlying rationale for such an approach is to reduce the number of player window elements a single reviewer need observe, this being a major concern in embodiments with a large number of cameras. In one embodiment there are thirty-two cameras, and eight technical reviewed are each assigned four of these cameras. In some embodiments the controller doubles as a technical reviewer.

Stations 303, 304 and 310 in some embodiments share common rooms, although in other embodiments they are located in two or more separate rooms.

Facility 301 includes communications units to allow the actor, controller and director to communicate in an efficient manner. In the embodiment of FIG. 3, capture station 302 includes a communications unit 315 including a microphone and loudspeaker. Unit 315 is coupled to a further unit 316 at controller station 303, this unit also including a microphone and a loudspeaker. This allows the controller (or other persons at the controller station) to audibly communicate with the actor (or other persons in the capture zone). Controller station 303 also includes a communications unit 317 in the form of a microphone coupled to a headset. Unit 317 is coupled to a similar unit 318 at director station 304 to allow audible communication between the director and controller. In one embodiment units 317 and 318 are portable and wirelessly coupled to allow the director to move freely around facility 301 whilst remaining in communication with the controller. In embodiments such as that of FIG. 3B the technical review station includes a communications unit 319 coupled to unit 317 to allow the technical reviewer or reviewers to audibly communicate with the controller.

In some embodiments a three-way audio communication arrangement is used whereby:
A first dedicated channel (such as push-to-talk) allows the director to communicate with the actor. In some cases the controller is able to hear such communication.
A second dedicated channel (again, such as push-to-talk) allows the controller to communicate with the actor. In some cases the director is able to hear such communication.
A third channel (such as a microphone provided for audio capture) whereby the actor broadcasts to both the director, controller, and optionally other parties.

In one embodiment this three-way audio communications arrangement is supplemented by a separate headset system which allows the director, controller and other parties other than the actor (such as hairstylists and the like) to communicate with one another. In some embodiments the hairstylists and/or other back-end parties to a production team are provided not only with headsets for audible communication, but also with viewing terminals/displays for observing the actor.

In some embodiments an autocue device is provided within capture station to feed lines and/or other direction to the actor silently. In some embodiments one or more similar devices are additionally installed for providing additional direction to the actor, for example to instruct regarding gaze direction or the like. For example, a moving object or pointer can identify a direction in which the actor should gaze over time.

In some embodiments there is an additional editor station for perform video editing operations (such as cutting or clipping) on approved takes to remove extraneous video data, as discussed in the context of “Editor Level” further above.

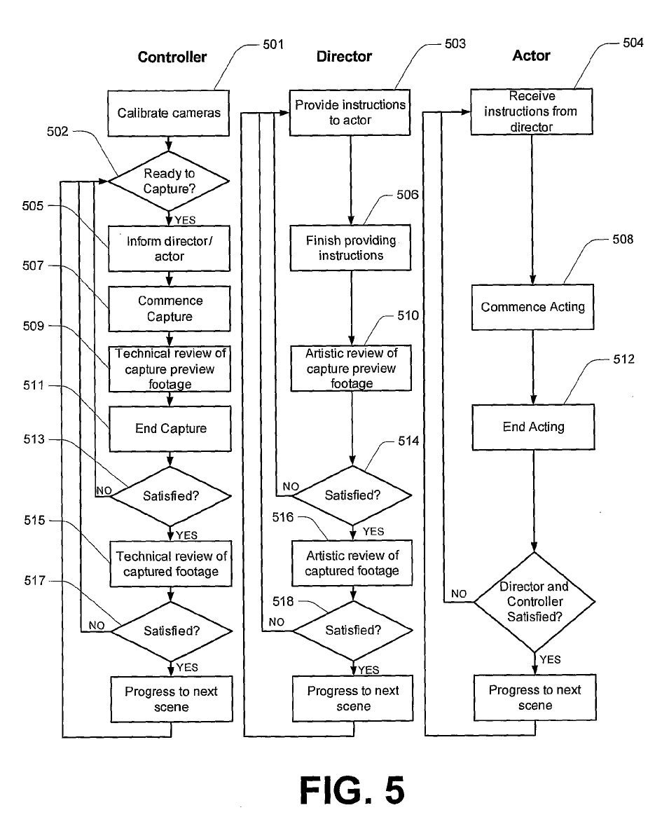

FIG. 5 illustrates an exemplary video capture process using facility 301, showing steps taken by each of the controller, director and actor. At 501 the controller is responsible for ensuring that cameras 106 are appropriately calibrated, and at 502 ensures that any other pre-capturing steps have been performed. During this time the actor is instructed by the director at 503 and 504. At 505 the controller informs the director that the system is ready to capture, and the director completes providing instructions at 506. At 507 the controller commences video capture, and instructs the actor to commence acting, acting commencing at 508. At 509 and 510 the controller and director review the footage that is being captured respectively for technical and acting characteristics. Capture and acting respectively end at 511 and 512, and either of these events may trigger the other depending on the circumstances. At 513 and 514 the controller and director decide whether they are satisfied with the footage they have seen. If not, the process returns to 502 and 503. Otherwise the controller and director optionally review the captured footage at 515 and 516, and again decide whether or not they are satisfied at 517 and 518. If they are satisfied, the method progresses to capture of the next take.

It will be recognized that there are two distinct levels of approval—one following review of captured footage in substantial real-time (by review of capture preview), another following a review of captured footage that has been stored. Due to network delays and resource availability, footage viewed in substantial real-time is typically of a relatively low quality. For example, only a selection of captured frames are actually shown. Reviewing this sort of footage provides only a preliminary indication of quality. Stored footage, on the other hand, is able to be reviewed at much higher quality, allowing for a more detailed review and a more complete assessment of quality. The configuration of system 101 allows stored footage to be reviewed in this manner substantially immediately following the completion of video capture. That is, the director and controller watch capture preview of the footage that is being captured in low quality, and then substantially immediately review that footage in high quality. A further advantage of having a further approval after captured footage has been stored stems from the director having a further opportunity to make a closer inspection and compare between takes.

Step 501 includes, at least in some embodiments, configuring cameras 106 and associated audio capture devices for time synchronization. Due in part to problems associated with network delays, this is in some embodiments carried out using hardware distinct from terminal 125, typically hardware coupled directly to the cameras and audio capture devices.

Upon approval of captured video by the controller and director, the animation generation process is commenced. In some embodiments the controller, provides a signal indicative of approval of captured video, and in response to this signal the captured video is transferred to the rendering subsystem for processing, thereby to commence the animation generation process. In other embodiments passive approval of captured video footage is sufficient to commence the animation generation process.

In some embodiments, upon approval of captured video, the controller subsequently provides instructions for some preliminary animation processing. This preliminary animation processing is used as an additional check in relation to the technical suitability of captured video, and typically involves animation processing procedure for one or a small number of frames such that a result is provided in a relatively short period of time. For example, in one embodiment it takes about ten hours to completely process one minute of captured footage. It may however be possible to process a handful of frames in a matter of minutes. One rationale for preliminary processing is to provide an opportunity to review such a result, and as such within a relatively short timeframe be in a position to decide whether a take should be recaptured. In some embodiments such results are available for review in a matter of minutes, increasing the likelihood that an actor will be available for a re-capture if necessary.

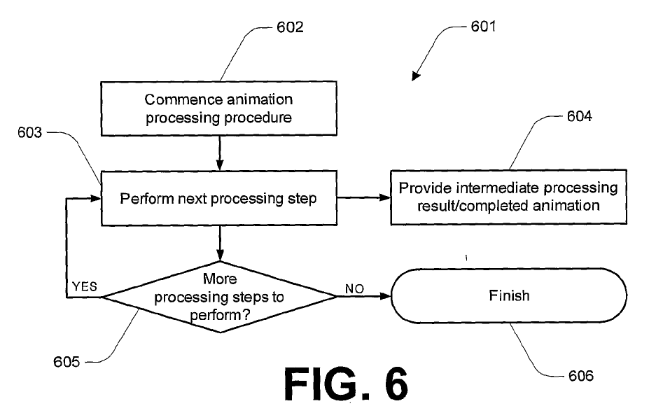

FIG. 6 shows a schematic overview of a processing procedure 601. In overview, the complete process of processing captured video to provide a video-based animation includes a number of individual processing steps. Process 601 is commenced at 602, and a first processing step carried out at 603. Upon completion of this step a result is provided at 604. This result is either an intermediate processing result or, in the case that all processing steps have been carried out, a completed video-based animation. At 605 it is considered whether any steps remain. In the case that no steps remain, the process completes at 606. Other wise the next processing step is performed at 602. It will be appreciated that this is very much a simplification of the overall process, and in some embodiments several steps are carries out simultaneously. Indeed, individual steps need only be performed sequentially in cases where a later step requires an intermediate processing result from an earlier step.

The decision at 605 takes into consideration not only whether there are any steps remaining in the overall process of providing a video-based animation, but also whether there are any steps remaining a process of providing an intermediate processing result requested by a user. That is, in some instances process 601 commences with an instruction to provide a retain level of processing corresponding to a certain tier of processing result. For example, where an intermediate step in the process of creating a video-based animation is the generation of a 3D mesh, process 601 may commence with an instruction to generate such a 3D mesh.

The term “processing steps” is used here to describe individually definable stages in the production of a video based animation. Examples include stereo matching, point filtering, point coloring, and mesh generation. The steps in a particular embodiment will depend on a specific animation technique being applied.

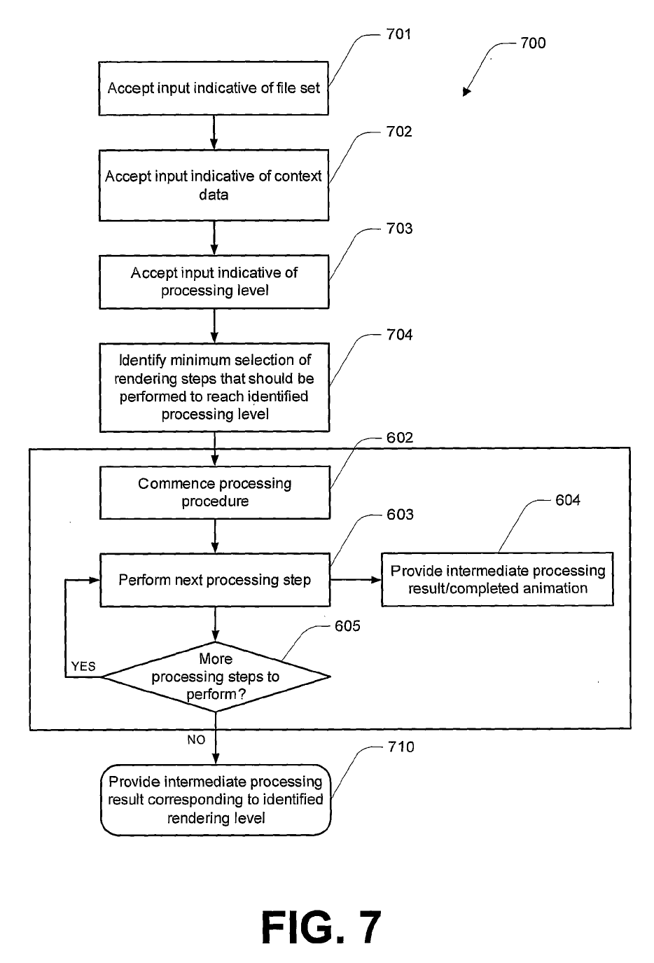

FIG. 7 shows a process 700 where a user is able to select a predefined processing level using an interface, such as GUI 130. At 701 a user identifies a video file set that is to form the basis of a video based animation. At 702 the user identifies context data to assist in the animation processing procedure. This context data typically includes video data showing an empty target zone (allowing background identification and elimination) and calibration information regarding the cameras used (allowing identification of the locations form which video was captured for each file in the set). At 703 the user selects a processing level, for example “perform the step of mesh generation”. In another embodiment the user selects an output a result tier, for example “provide a mesh generation result”. At 704 the minimum selection of processing steps required to achieve the selected processing level are identified, and subsequently process 601 performed to produce the relevant intermediate processing result at 710.

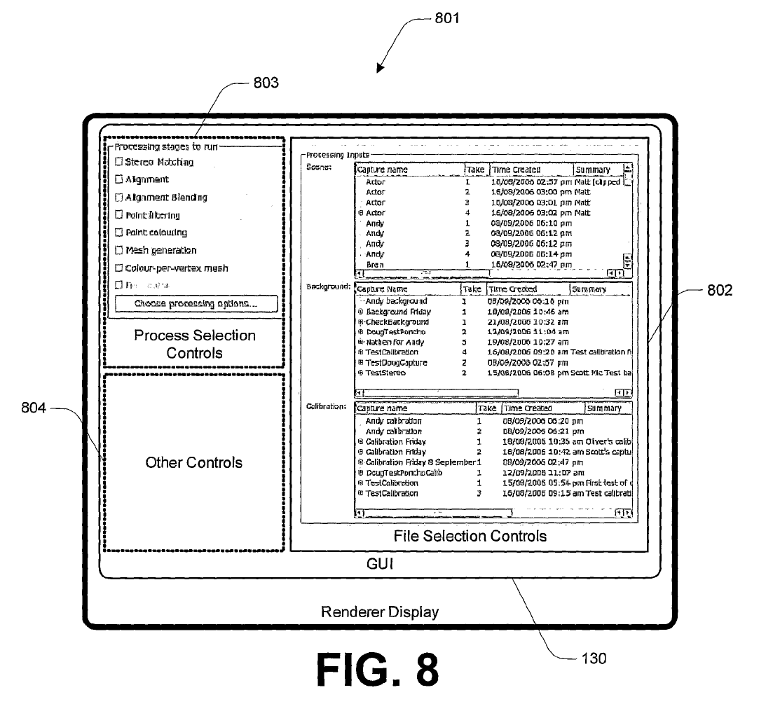

FIG. 8 illustrates an exemplary screenshot 801 from GUI 130, showing a “render management” mode. This mode is used by a controller or renderer to manage the process of generating video-based animation from a video file set stored at subsystem 115, in one embodiment following process 700. Screenshot 801 shows two major elements: a “file selection controls” element 802 which obtains user input for step 702 and step 703, and a “process selection controls” element 804 which obtains user input for step 704. There are also other controls 805 for accessing various other functionalities.

Intermediate processing results and completed animations are viewable via GUI 130 in a specialized 3D media player. This includes all intermediate results, not only those specifically requested by a user. In some embodiments additional video equipment is used in parallel to that required for capturing video in connection with a video-based animation. For example, in some embodiments a secondary video system (such as a webcam other low-bandwidth system) is implemented to allow monitoring of the capture station at either or both of a controller station and director station.

It will be appreciated that process 700 allows intermediate results to access points for quality control and re-processing. In one embodiment intermediate results are used to identify problems at an early stage. This not only reduces wasting of time and computational resources, but also increases the likelihood that an actor will be available for the re-capture of a take, should that be necessary.

In some embodiments, the general concept of “processing steps” is implemented in the context of tasks and jobs, as discussed below.

In some embodiments, three tiers of “task” are defined: Group of Tasks (user submission level), Task (processing and data manipulation level) and Subtask (algorithm level).

Groups of Tasks (GoTs) reside at the user submission level. That is, a user submits work in units of GoTs, which can be named, assigned a priority and hardware configuration/requirement A GoT, once approved by the user, is submitted for processing. In some cases a GoT additionally includes a user ID associated with the user that submitted the GoT. The ability to process a given GoT might rely on the completion (or partial completion) of another GoT (for example, a GoT involving processing multiple takes might rely on completion of another GoT whereby the relevant video data is loaded from tape and edited. Once a GoT is submitted for processing, its constituent tasks and subtasks are locked so that their types, inputs and outputs may not be modified until the user explicitly cancels or modifies them.

Tasks reside at the processing and data manipulation level. A task is a logical unit of work. A task falls into one or more task categories, including but not limited to:
Full or partial processing of a set of video data to respectfully provide either an animation file or an intermediate result (i.e. to provide a checkpoint to allow quality control to be performed prior to subsequent processing to ensure that such processing is worthwhile).
Video editing: for example, cutting a take or combining frames from existing video files to define a new video file, or other video editing operations.
Reprocessing existing takes from intermediates stages/checkpoints with different algorithm parameters.
Data transfer of captures/takes/end results from one storage to another (e.g. tape to disk, disk to tape, disk to disk).

Subtasks are smaller units of work within a task. For data processing, each subtask can represent an algorithm in the processing pipeline (such as stereo matching). For data transfer, it could be copying one take for a task of copying a whole capture session to disk. In overview, subtasks define the smallest unit that a user has control over during task submission and task scheduling.

In defining a GoT, a user selects one or more tasks, and for each task identifies those subtasks that are desired. In some embodiments, each task defines a predefined group of subtasks, and all are selected by default (i.e. it is presumed that all are desired). For each subtask, it is necessary to identify a target for the subtask, and other specific information that may be required. That is, details are required to tie the subtask to a particular situation. For example, where a subtask type relates to a particular aspect of data processing (such as stereo matching), the target would be a particular file set. Where a task type relates to video clipping, the target would again be a particular file set, and specific information might include the first and final frames to be clipped. In some cases, details for subtasks are provided by a user at the task level (and apply across all constituent subtasks), rather than being provided individually for each subtask. For example, this includes camera calibration data which is applied to all subtasks in a data processing task.

A significant advantage stemming from the use of tasks and subtasks related to user-definition of “pause-points”. These are stages in the processing pipeline where an intermediate result is generated for review by technical personnel. In the process of defining a GOT, a user is able to determine the number and location of pause-points, and associate rules with those pause points. For instance, in some cases a pause-point prevents downstream processing being performed in relation to a given intermediate result until that intermediate result has been approved by a technical reviewer. It will be appreciated that such an approach seeks to reduce the likelihood of processing and/or memory resources being wasted in performing a subtask or multiple subtasks based on an unsatisfactory input. Instead, where an unsatisfactory intermediate result is identified, the user is able to retrace the source of the problem, which might require re-capturing a scene or resubmitting one or more subtasks (by way of a new GoT or modifying an existing GoT) such that the one or more subtasks are performed based on different parameters.

In practice, a user defines a GoT and its constituent tasks and subtasks. These are submitted for processing and, at the machine level, parsed/converted into jobs and subjobs, as discussed below.

In the context of a job, when a GoT is submitted for processing, the associated tasks and subtasks are divided up into jobs. Generally speaking, a job is defined for each subtask or, where a task includes only a single subtask (i.e. the subtask defines the task wholly), a job is defined for such a task. In some cases sequential subtasks are combined into a single job to improve processing efficiency. For example, to reduce disk IO or improve buffering by grouping tasks that make use of similar data that may be locally buffered (for example point cloud filtering and mesh generation).

A subjob represents an incremental unit of work existing within a job (this is in some cases the smallest unit that may be managed for load balancing, by starting, stopping, pausing, or reassigning to different processing nodes). These are, in some embodiments, defined based on hardware configurations of processing nodes available and the actual jobs in the job queue, optionally in additional to user-defined constraints. A subjob may represent the processing of a subset of the frames that are to be processed for completion of a job. For example, where a job includes performing stereo matching on X frames, n subjobs are defined which each define performing stereo matching on X/n of the frames (noting that this might require consideration of further adjacent frames in each instance, for example to facilitate temporal filtering). In this manner, similar subjobs for a take (but relating to different subsets of frames) may be processed in parallel. In some cases advantage is taken of this functionality to reduce processing times for particularly sensitive takes. For example, in one embodiment the manner in which subjobs are defined for a particular job is determined by reference to a priority rating associated with the job (for example this may be associated with the corresponding GoT, task, take, or the like). For example, in some cases a GoT or capture set is given a relatively higher priority due to issues concerning an actor concerned. For example, where an actor having limited availability or receiving a high rate of pay is filmed, there is a particular sensitivity to process the resultant video data as a high priority such that a need to re-capture one or more takes can be identified at the earliest possible opportunity. Additionally, given that there is no inter-take dependency during data processing, it is possible to increase efficiency by processing multiple takes of a given scene in parallel.

In the context of processing, subjobs are arranged in a queue based on relative priorities (which may be user defined) and relative dependencies (which are defined based on a set of dependency rules which establish which subjobs must be completed before the commencement of other subjobs, for example where the output of one is required as input for another). A subjob is assigned to a processing node, and subsequently a success or failure response is received. If a success response is received, the next waiting subjob is, generally speaking, assigned to that node. In the case of a failure, the current subjob is restarted on the same or a different processing node.

In some embodiments, other error handling mechanisms are used. For example, one embodiment makes use of a “failed list” whereby a user is notified of failed subjobs. In some cases an electronic message (such as SMS, email, or the like) is used to notify an administrator if a processing unit is consistently failing subjobs. It will be appreciated that this suggests substantive hardware or configuration issues.

In some embodiments there is a “look ahead” process such that data is able to be buffered on a processing node for an upcoming next subjob to be processed on that node.

In terms of dependencies, there are dependencies between tasks, and within a task there are dependencies between subtasks. Task/subtask level dependencies are based on a predefined capture protocol and algorithm sequence. Similarly they translate to job and subjob dependencies, where dependency rules to allow jobs/subjobs to be performed in a guided/restricted order. Dependency rules are associative such that binary operations such as “is before” and “is after” can be used to suggest order.

In some embodiments job/subjob priorities are automatically adjusted based on waiting times, typically resulting in increased priority over time so as to avoid jobs being starved of cycles (i.e. having prolonged waiting times).

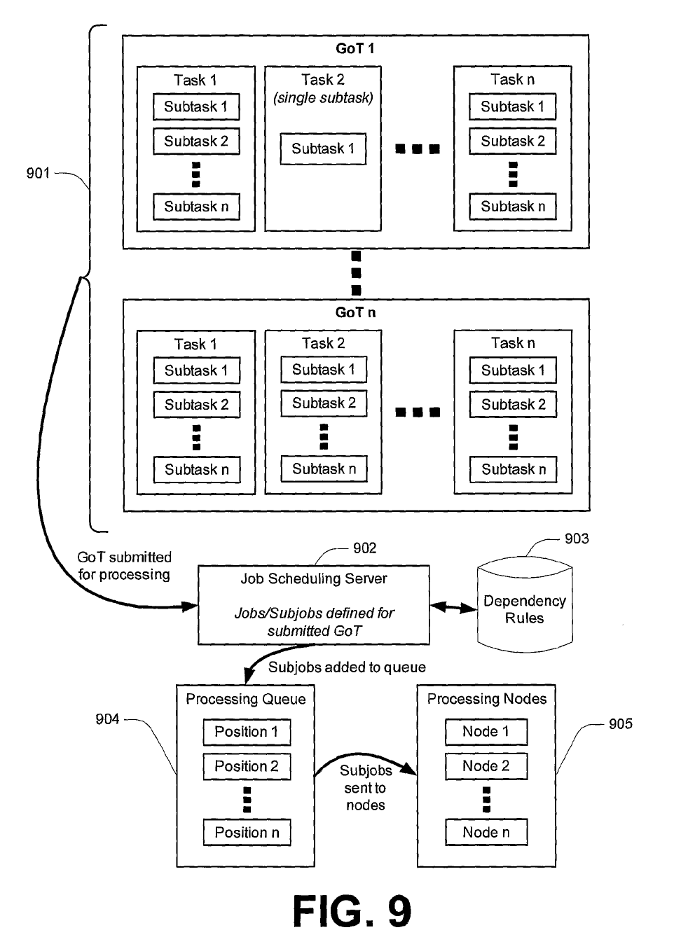

FIG. 9 schematically illustrates a task/job environment according to one embodiment. In overview, a user defines one or more GoTs 901 (in some cases, multiple users have this ability). Each GoT includes one or more tasks having respective subtasks. Once a user is satisfied with the content of a GoT (i.e. tasks, subtasks, priority, etc) the GoT is submitted to a job scheduling server 902. This server operates in conjunction with a dependency rule database 903 for defining jobs and subjobs corresponding to the relevant GoT. Subjobs, once defined, are added to a processing queue 904. Upon processing/memory resources becoming available, the next job in the queue is sent to a processing node 905 for execution.

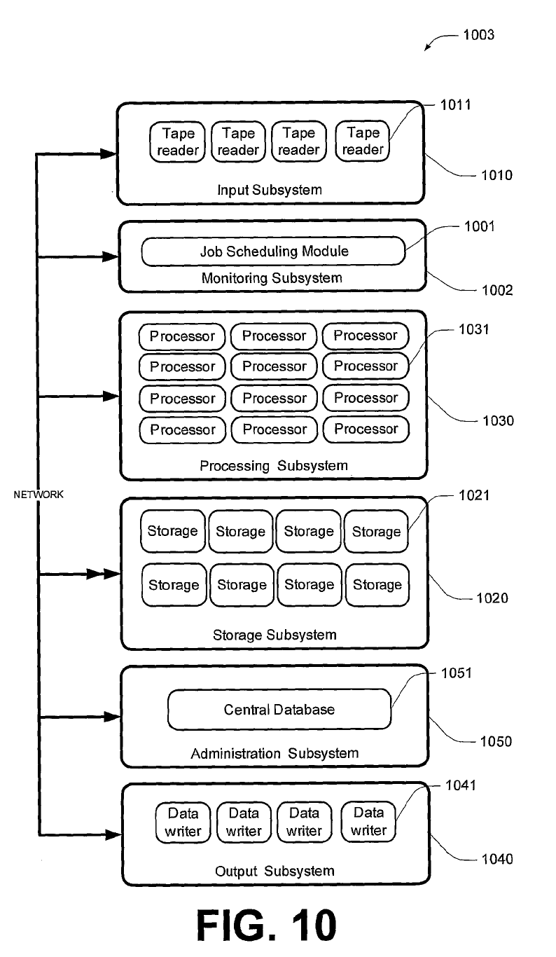

A further embodiment of the invention takes the form of a computer program product for managing the production of a free-viewpoint video-based animation, for example in terms of tasks and jobs as discussed above. The computer program product is presently referred to as Job Scheduling Module (JSM) 1001, shown in FIG. 10. In the context of FIG. 10, JSM 1001 executes on a monitoring subsystem 1002. For example, subsystem 1002 includes a memory module for carrying computer executable instructions at least partially defining JSM 1001, and further includes one or more processors for executing those instructions. It will be appreciated that a discrete subsystem 1002 is illustrated primarily for convenience, and that in other implementations JSM 1001 executes on an alternate one or more platforms.

JSM 1001 operates in the context of a production system 1003. At a broad conceptual level, system 1003 includes an input for receiving video data and an output for providing data indicative of a free-viewpoint video-based animation (referred to as an “animation file” for the sake of the present examples). Intermediate the input and the output are components that process the video data so as to generate the free-viewpoint video-based animation. System 1003 is configured for implementation in a commercial environment, and as such is required to simultaneously manage multiple capture sets for the production of multiple free-viewpoint video-based animations. Commercial pressures additionally give rise to a desire that multiple capture sets are processed in an efficient manner, and by reference to their relative priorities (determined objectively and subjectively). For example, in some cases a capture set is given a relatively higher priority due to issues concerning an actor that is filmed in that set. For example, where an actor having limited availability or receiving a high rate of pay is filmed, there is a particular sensitivity to process the resultant video data as a high priority such that a need to re-capture one or more scenes can be identified at the earliest possible opportunity.

In the present embodiment, JSM 1001 is configured primarily to allow tasks to be prioritized in a predetermined manner so as to provide a degree of efficiency to the production process. In some embodiments, modes of prioritization are modified dynamically based on user input and system processing statistics. This essentially provides a learning approach where the JSM monitors how the system is performing and makes adjustments so as to ease the bottlenecks and reduce the likelihood of previous mistakes being repeated.

System 1003 is able to be considered as including a plurality of subsystems (presently including modular subsystems), these being defined substantially by their respective functions. These subsystems are essentially coupled together by way of a high speed network 1005, such as a Myranet network, Inifiniband network, fiber channel switching arrangement, 10 Gigabit or gigabit Ethernet network, or the like. In some cases network 1005 is defined by a plurality of distinct networks or inter-component connections.

For the sake of the present discussion, system 1003 is substantially described in a manner that omits various components discussed in previous examples, in particular a capture subsystem and other components concerned with the initial capture and preliminary review of video. Although in some embodiments system 1003 includes such components, in some cases system 1003 operates isolated from such components. For example, by reference to FIG. 2, in some cases the steps preceding step 208 are performed at a first location, whilst steps from 208 onwards are performed at a second location. In some instances data is transferred between these locations by tape or other physical portable substrate, effectively creating a separation between capture and rendering subsystems. However, in other instances a wider network is used to transfer this data.

As a result of the present manner by which system 1003 is described, to some extent it defines a rendering subsystem, such as subsystem 115 described above, in combination with associated components that allow for process management and the like.

An input subsystem 1010 is provided for receiving input data, presently including capture set data (i.e. data indicative of one or more file sets), which is received in units. Each unit of capture set data includes a plurality of video files for a given take (i.e. video files simultaneously captured from a plurality of cameras arranged in an array, defining a “file set” as described above, typically with associated audio data) and configuration/calibration data for that take. In some embodiments the configuration/calibration data is directly provided, whereas in other embodiments the configuration/calibration data is indirectly provided (for example by way of association to configuration/calibration data available at another location). Additional data and/or meta data is also received in some embodiments.

In most cases, a single final-product video-based animation is to be generated for each unit of capture set date (i.e. for each file set). For the sake of the present example, this final-product animation is described as being embodied in an “animation file”. This is essentially a collection of data that is provided as an end product for delivery to a client, such as a video game or animation feature development group. The animation file is then implemented as desired by the client (for example it is put to use in the context of a video game).

In some embodiments the input subsystem is defined by a capture subsystem such as subsystem 102 described above, or a connection to such a capture subsystem. However, by way of an alternative example, as illustrated, subsystem 1010 is separated from such a subsystem, and makes use of a modular design. Specifically, this is illustrated in FIG. 10 by way of a plurality of tape readers 1011 for reading data stored on digital data storage tapes. However, in other embodiments capture set data is provided by media other than tape (either as an alternative or in combination). For example, in some cases subsystem 1010 includes a network connection to a remote (local or extra-jurisdictional) location where video data is located. In the case of tapes, these are in some cases manually loaded, and in other cases automatically loaded by way of a mechanical stacker or the like. In some cases tape libraries are scripted and controlled by software, optionally in combination with barcode tagging of physical tapes.

A storage subsystem 1020 includes a plurality of storage modules 1021. The manner by which these storage modules are defined varies between implementations. For example, in some cases each storage module represents a single storage device, or a collection of grouped storage devices (for example in a RAID configuration, where there are multiple HDDs). In other cases each storage module represents a virtualized allocation of storage on one or more physical storage devices (for example each storage module represents a predetermined allocation of storage resources).

Insofar as the storage subsystem in concerned, storage options include distributed file systems (such as GPFS), a packaged solution with one global namespace (e.g. NetApp), or multiple individual systems to partition takes based on capture sessions, customers, persons doing the processing. For example, in some embodiments each person responsible for coordinating a respective collection of file sets is assigned a virtual or physical allocation of storage resources.

A processing subsystem 1030 includes a plurality of processing modules 1031. These processing modules are either physically defined (i.e. each is defined by one or more processors) or virtually defined (i.e. each is defined by a predetermined allocation of processing resources). In some embodiments the processors each have access to a memory module that stores code for software processes to be executed on the processor.

An output subsystem 1040 includes one or more data writers 1041. The term “data writer” should be read broadly to include substantially any component capable of providing an output indicative of an animation file for a free-viewpoint video-based animation. For example, the writers might include components for writing to digital media (CD/DVD/BluRay/tape/etc) or a serial/network/other connection to a local or remote secondary storage location.

An administration subsystem 1050 includes a central database 1051. This database maintains data indicative of processing steps to be completed (and associated data relating to the likes of work orders, activities, tasks or jobs, as discussed further below), records relating to capture sets, scenes, takes, customer details, job submission, etc. From a hardware management perspective, there might be a record for each camera, capture server, and processing node. Essentially, the database is configured to maintain any meta data that is of potential interest regarding the overall system (which might include a capture subsystem, and the like, as discussed in previous examples). This allows for additional functionalities, such as client billing based on processing resources/time consumed, and so on.

JSM 1001 monitors characteristics of one or more of the other subsystems to derive input data indicative of operational characteristics, and uses this input data to make decisions and provide commands in the context of animation generation functions. In particular, JSM 1001 monitors operational characteristics concerning processing subsystem 1030. For example, according to one implementation each processing module executes a monitoring utility which continually provides to JSM 1001 data indicative of processing resource utilization. JSM 1001 is in this manner able to determine which processing modules are being utilized and which are not being utilized. In some embodiments reporting additionally allows JSM 1001 to receive input regarding a task assigned to each processing module, the status of that task (i.e. percentage completed, anticipated time remaining, etc), and information regarding errors and failures.

In some embodiments, the input data includes both static data (for example concerning hardware/software configuration and statistics on the contents of multiple takes) and dynamic data (for example concerning current loads in the processing system and the activity of individual processing modules, including hardware failures).

In some embodiments JSM 1001 monitors the operation of subsystem 1010, and provides commands that affect the operation of readers 1011. For example, JSM 1001 provides commands that directly or indirectly initiate and/or terminate transfer of data from tapes. In some embodiments, JSM 1001 additionally provides notifications upon all data being transferred from a tape. In some embodiments JSM 1001 monitors the operation of subsystem 1020 so as to maintain information regarding availability of storage resources, and other operational characteristics regarding storage modules (such as errors and so on). In some cases, monitoring of subsystems 1010 and 1020 is indirect, and achieved by reporting from subsystem 1030 (i.e. from processes that essentially control operations in the other subsystems).

In one embodiment, a daemon executes on each file server in the processing subsystem, the functionality of which is to report system status (storage availability for example). This can also be reported by hardware means, such as a hardware management card that is configured to monitor how a server unit is functioning. These provide to the JSM information to assist in determinations concerning when and how data transfer and processing are performed.

It will be appreciated that, generally speaking, the need to execute a daemon on each server unit within the system to monitor hardware usage depends on the level of hardware support available already via hardware management cards. In some cases there is a daemon running on each individual processing unit, and a further daemon running on a central database server to monitor CPU and network load across the system.

In some embodiments a disk buffer is implemented to improve tape library performance by buffering data. This reduces the extent to which a tape library might be affected by network traffic and storage device IO loads during data transfer.

In some embodiments the storage subsystem includes a plurality of disk groups, these being defined among the storage modules within the storage subsystem based on disk IO performance. For example, a first group is optionally defined by a comparatively small number of comparatively faster drives (e.g. SCSI, SAS and Fiber channel drives), and a second group is optionally defined by a comparatively larger number of comparatively slower drives (e.g. SATA). By monitoring the age of data or the status of job completion, the JSM is able to provide instructions such that older data is migrated to the second group (i.e. the slower disks) assuming it will be used less frequently. This also allows for a streamlined process whereby data is deleted based on age

It will be appreciated that monitoring of operational characteristics assists in the effective implementation of a scalable architecture. For example, an additional processing module is able to be added, and JSM 1001 is able to recognize and utilize the resulting additional resources.

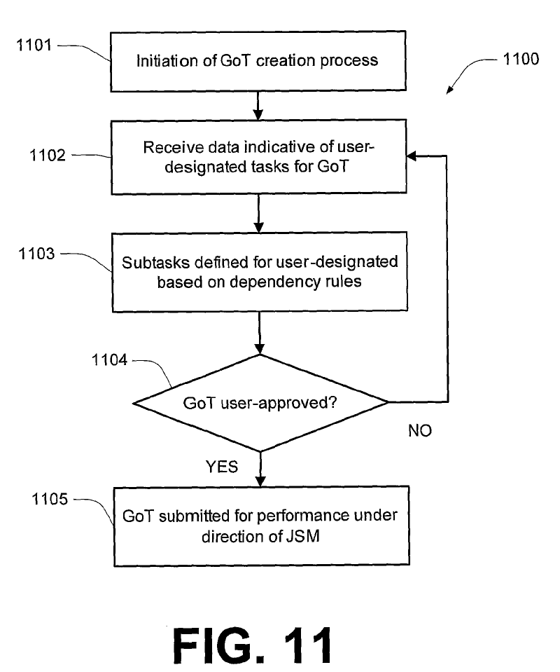

FIG. 11 illustrates an exemplary method 1100 by which a GoT is created and submitted for performance. Step 1101 includes the initiation of a GoT creation process. For example, a user submits by way of a software application a request to create a new GoT. This software application is, in some cases, a utility related to the JSM. In other cases, it is part of the JSM. In the present embodiment step 1101 additionally includes assigning a priority rating to the GoT. Step 1121 includes receiving data indicative of user-designated tasks. For example, the user identifies a file set (or multiple file sets) to which the GoT relates, and determines which of the available tasks are to be undertaken. In some cases an interface is provided whereby the user selects a beginning stage (such as reading data from disk or a certain intermediate result) and a final stage (such as outputting an animation file to removable storage or providing an intermediate result), and the necessary/suggested tasks required to progress from that beginning stage to that final stage are automatically identified. Once the user has designated tasks for the GoT, these are processed at 1103 based on the dependency rules to define subtasks, and in some cases dependency relationships between those subtasks. At 1104 it is determined whether the GoT is approved by the user. If not, the method loops to 1102 such that the user is able to modify tasks. Otherwise, the GoT is submitted for performance under direction of the JSM at 1105.

In some embodiments a task editor allows a user to adjust processing task flow, parameters that are to be used, and which subtasks to be added or removed from those included by default for a given task. Such customizations are assessed on the basis of dependency rules and other criteria do determine whether the task meets suitability requirements (i.e. whether it is able to be parsed and/or executed). Such error checking prevents GoTs from being submitted unless they are in a suitable format.

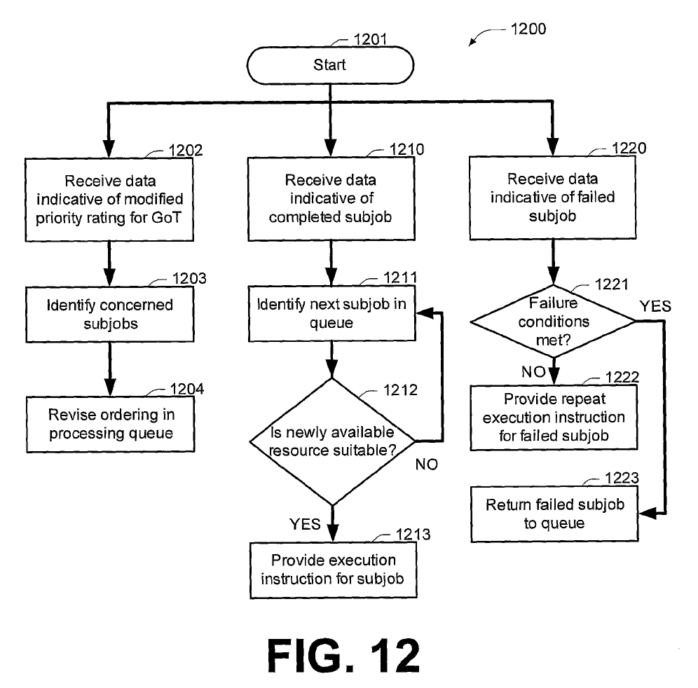

Referring now to FIG. 12, method 1200 illustrates an exemplary process whereby one or more GoTs are performed under instruction of the JSM. FIG. 12 includes three separate process strings, each commencing from a common start point 1201. Depending on the circumstances, upon the completion of one string the method includes either repeating that string, progressing to another, or waiting for further input.

The first string commences at 1202, which includes receiving data indicative of a modified priority rating for a GOT. For example, a user identifies a particular submitted GOT that should be of greater or lesser priority than is presently the case. This might occur where an actor's availability lessens, demanding expedited processing of his/her takes. Step 1203 includes identifying the subjobs belonging to the relevant GOT. At this stage, these subjobs are queued and awaiting execution, with the ordering within the queue being based on preexisting prioritization information. Step 1204 includes reordering the queue based on the modified prioritization information received at 1202. That is, at the individual subjob level, one or more subjobs are moved forwards or backwards in the queue. This allows dynamic re-ranking over time based on user input.

The second string commences at 1210, which includes receiving data indicative of a completed subjob. It will be appreciated that this corresponds to processing resources becoming available. Step 1211 includes identifying the next subjob in the queue, and step 1213 includes determining whether the newly available processing resource is suitable for that subjob (as discussed, subjobs have respective processing and/or memory requirements). If the resource is suitable, an instruction to execute that subjob is provided. Otherwise, the method loops to step 1211 where the next waiting subjob is considered. This looping continues until a subjob is identified for which the resources are suitable.

The third string commences at 1220, which includes receiving data indicative of a failed subjob. At 1221 it is considered whether predetermined failure conditions have been met. For example, if the subjob has filed previously on one or more occasions, or if the hardware is displaying certain health characteristics. If the predetermined failure conditions are not met, a repeat instruction is provided such that the node attempts to process the subjob once again. Otherwise, the subjob is returned to the queue, typically at the top such that it is processed using the next available set of suitable resources. In some embodiments different subjobs are subsequently provided to the node responsible for the failure and additional logic implemented to better understand whether the failure was due to problems at the node or problems associated with the failed subjob. Where the problem is with the node, an alert is created such that attention can be given to that problem. There the problem is with the subjob, a different alert is created such that the subjob can be reviewed.

For the sake of a further example, the processes managed by JSM 1001 are refereed to as “work orders” and “activities”. The term “work order” is essentially used to describe the overall process whereby a unit or capture set data is imported, used to generate a final-product animation file (or a subset of this overall process, such as a group of intermediate processing steps moving from one intermediate result to a second intermediate result, from video data to an intermediate result, or from an intermediate result to a final-product animation file), and the file exported. Each “work order” includes a plurality of “activities”, such as loading of data from tapes to the storage subsystem, video decompression, corner detection, mesh generation, point cloud generation, stereo matching, purging of temporary files and/or intermediate results, and so on. It will be appreciated that the precise process by which a free-viewpoint video-based animation is created varies between implementation, and generally falls beyond the scope of the present disclosure. JSM 1001, as described below, provides a framework for managing the production of such an animation regardless of the precise process used.

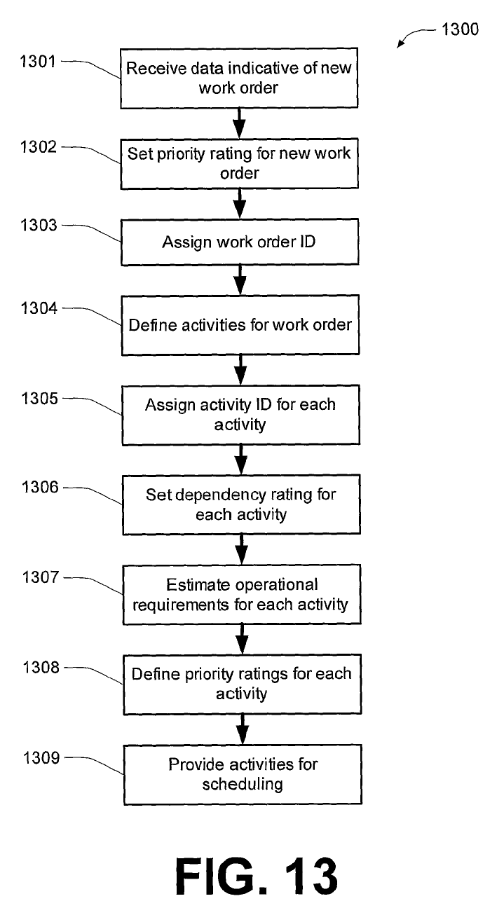

JSM 1001 operates in combination with a dependency protocol that defines data requirements for each activity type. For instance, consider three hypothetical activity types: Type A, Type B and Type C (in practice these describe activities such as stereo matching, and so on). The dependency protocol might define, for example, “Type A before Type B” and “Type B before Type C” (implying “Type A before Type C”). In the course of configuring JSM 1001, all of the various data processes involved in the production of an animation are considered based on aspects of interdependence (primarily based on data input), and an appropriate dependency record defined appropriately. FIG. 13 illustrates an exemplary method for 1300 importing a new work order into JSM 1001. Data indicative of a new work order is received at 1301. In some embodiments this includes manual user input identifying that a particular unit of capture set data should be treated as a work order. In some embodiments a prompt for such input is generated upon a new unit of capture set data being observed at subsystem 1010.

A priority rating is able to be manually set for the new work order at 1302. This is an optional step, and omitted in some embodiments. JSM 1001 provides functionalities for prioritizing activities based on factors such as resource requirements and work order age, however in some cases step 1302 is used to provide a manual override such that a newer work order is given a relatively higher priority rating than would otherwise be the case. A work order ID is assigned at 1303. This ID uniquely identifies a particular work order, and optionally conveys additional information such as priority and purpose. In some embodiments priority is able to modified on a dynamic basis, thus changing the order of work orders and activities as they are executed.

Sub-process 1304 includes defining activities for the new work order based on previously defined activity types. Each activity is assigned a unique activity ID at 1305. Dependency ratings are assigned to each activity at 1306, these being based on information in the dependency protocol. Estimates of operational requirements for each activity are made at 1307, these optionally being expressed in terms of processing and memory load requirements. In some embodiments these are standard for each activity type. In other embodiments an estimation calculation protocol is provided for each activity type, and a more detailed estimate prepared using input such as the number of video frames in the relevant unit of video set data. Sub-process 1008 includes defining priority ratings for each activity. In some cases these priority ratings simply follow from the parent work order. However, in other cases a more advanced algorithm is used, optionally considering the number of activities nested below a given activity according to dependencies. A activity having a relatively larger number of dependent activities is often assigned a relatively higher rating. Of course, regardless of relative priority ratings, ordering based on the dependency rules is an overriding factor given that, in the event of a contravention in the dependency rules, jobs and/or subjobs will fail (due to missing input data, for instance).

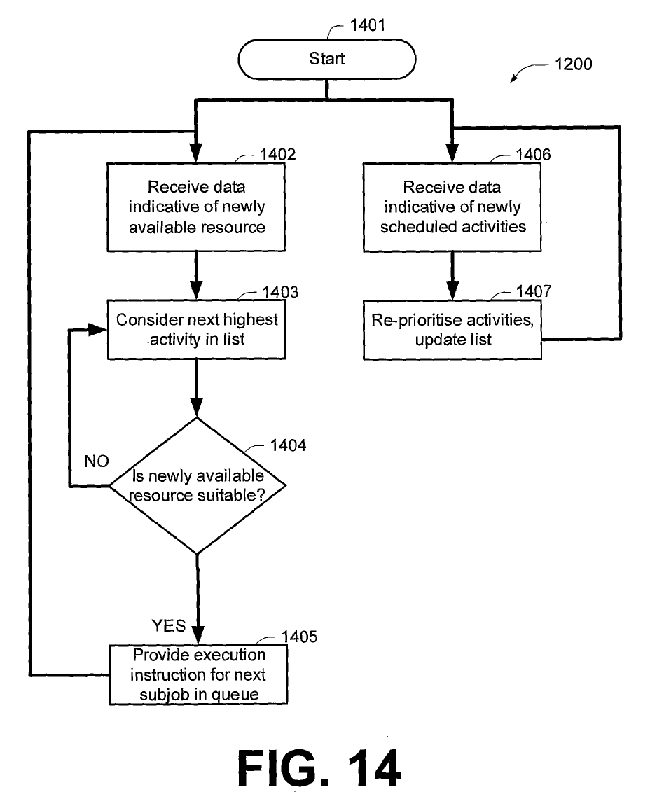

Sub-process 1309 includes providing the defined activities for scheduling. In some embodiment this includes defining entries in central database 1051 for each activity, each record including details of priority rating, estimated operational requirements and dependency ratings. The entries in the activity database are then automatically prioritized to create a activity list, which is provided for execution by JSM 1001, for example in accordance with the method of FIG. 14.

FIG. 14 illustrates a method 1400 for managing scheduled activities. The process commences at 1401, this typically being defined upon initialization of JSM 1001, at which time an activity list is defined based on existing activities defined in the activity database. As illustrated, method 1400 is not concerned with initialization or preliminary actions. The focus is primarily on two major forms of event: changes in resources, and changes in activities.

Data indicative of a change in resources is received at 1402. For example, in some cases this occurs where a processing module completes a previously assigned activity, or where an additional processing module is added to subsystem 1030. In response, the JSM looks to the next highest activity in the activity list. Decision 1403 includes considering whether the available resource is suitable for the activity on hand. If not, the method loops to 1402 and considers the next activity in the list. Otherwise, an execution instruction is provided at 1404.

Data indicative of newly scheduled activities (relating to one or more work orders) is receives at 1406. In response to this, the activity list is updated at 1407 such that reprioritization occurs. In this manner, activities belonging to urgent work orders are able to be dealt with in an appropriate manner. In some embodiments the JSM allows a user to start, pause, stop, or cancel activities individually or as a group dynamically. Similarly, priorities are in some cases able to be adjusted on the fly.

It will be appreciated that the disclosure above provides various systems and methods for managing the production of video based animation. In overview, and iterative approach is suggested whereby quality and performance checks are made on an ongoing basis such that deficiencies in captured footage might be identified at an early stage, increasing the probability that such deficiencies can be overcome by re-capturing footage without inconveniencing professional actors or directors.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be includes in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while some diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors, e.g., one or more processors that are part of building management system. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions a propagated signal and representing the set of instructions, and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this, Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1-33. (canceled)

34. A method for managing the production of a free-viewpoint video-based animation, the method including the steps of:
obtaining data indicative of one or more operational characteristics of a capture subsystem, the capture subsystem being configured for controlling a set of video capture devices and for storing video captured at each of these devices on a first storage device, the set of capture devices being configured to define a capture zone in three dimensional space for containing a target object;
accepting as input a first command indicative of an instruction to commence video capture;
being responsive to the first command for selectively providing to the capture subsystem a second command indicative of an instruction to commence video capture at the capture devices;
identifying video capture files stored on the first storage device corresponding to video captured at each of the capture devices in response to the second command, the identified video capture filed representing a file set;
providing an interface for allowing playback of the file set, wherein the interface allows selective simultaneous display of a plurality of player elements each for providing synchronised playback of a respective one of the video capture files in the file set thereby to allow review by one or more persons of video captured in response to the second command;
accepting input indicative of either approval or rejection of the file set and, in the case of approval of the file set, providing a third command indicative of an instruction to move the file set to a rendering subsystem;
selectively providing additional commands to the rendering subsystem indicative of instructions to process the file set to produce a free-viewpoint video-based animation of the target object.

35. A method according to claim 34, wherein the interface allows viewing of capture preview substantially in real-time.

36. A method according to claim 34, wherein the interface allows selective repeatable playback of the file set.

37. A method for managing the production of a free-viewpoint video-based animation of at least part of an actor, the method including the steps of:
providing a set of video capture devices and for storing video captured at each of these devices on a first storage device, the set of capture devices being configured to define a capture zone in three dimensional space for containing at least part of an actor;
instructing the actor to act out a scene at least partially within the capture zone;
instructing each of the capture devices to capture video of the scene;
reviewing acting characteristics of the captured video, and in the case that the acting characteristics do not meet a threshold acting quality standard, instructing the actor to act out a replacement scene;
reviewing technical characteristics of the captured video, and in the case that the acting characteristics do not meet a threshold technical quality standard, instructing the actor to act out a replacement scene;
in the case that the captured video meets the threshold acting quality standard and the threshold technical quality standard, providing an instruction indicative of approval of the captured video; and
being responsive to the approval of the captured video for commencing the generation of the animation.

38. A method according to claim 37, wherein commencing the animation includes transferring the captured video from a capture subsystem to a rendering subsystem.

39. A method according to claim 37, wherein either or both of the threshold technical quality standard and threshold acting quality standard subjective thresholds.

40. A method for managing the production of one or more free-viewpoint video-based animations, the method including the steps of
(a) providing an interface for allowing user-creation and submission of one or more groups of tasks related to the production of a free-viewpoint video-based animation, each group of tasks having an associated priority rating;
(b) being responsive to submission of a group of tasks for defining one or more subjobs for execution;
(c) on the basis of the priority rating for the submitted group of tasks and a set of dependency rules, adding the one or more subjobs to a prioritised processing queue; and
(d) being responsive to a signal indicative of resource availability at a processing node for providing the next subjob in the queue to the processing node.

41. A method according to claim 40, wherein step (a) includes providing to the user a selection interface for selecting one or more of a plurality of predefined tasks, wherein user creation of a group of tasks includes identifying one or more of the predefined tasks and, for each of the predefined tasks, target data.

42. A method according to claim 41, wherein the plurality of predefined tasks include one or more of the following:
full processing of a set of video data to provide a free-viewpoint video-based animation;
partial processing of a set of video data to provide an intermediate result in the production of a free-viewpoint video-based animation;
video editing of a set of video data;
data transfer of a set of video data from a first storage location to a second storage location; and
data transfer of a set of a file embodying a free-viewpoint video-based animation from a third storage location to a fourth storage location.

43. A method according to claim 41, wherein at least one of plurality of predefined tasks includes a plurality of default constituent subtasks.

44. A method according to claim 43, wherein the interface allows a user to modify the default constituent subtasks thereby to define custom constituent subtasks.

45. A method-according to claim 41, wherein the target data includes at least a portion of a file set including video capture files corresponding to video simultaneously captured at each of a plurality of stereoscopically arranged capture devices.
